(19) United States
(12) Patent Application Publication
(10) Pub. No.: US 2010/0094496 A1
(43) Pub. Date: Apr. 15, 2010

(54) System and Method for Operating an Electric Vehicle

(76) Inventors: Barak Hershkovitz, Even Yehuda (IL); Yuval Gilboa, Pardesiya (IL); Tamir Khason, Modiin (IL); Boris Kabisher, Yoqneam Illit (IL); Shahaf Kieslestein, Adar (IL); Shai Agassi, Palo Alto, CA (US)

Correspondence Address: MORGAN, LEWIS & BOCKIUS, LLP. (PA), 2 PALO ALTO SQUARE, 3000 EL CAMINO REAL, SUITE 700, PALO ALTO, CA, 94306, US

(21) Appl. No.: 12/560,337

(22) Filed: Sep. 15, 2009

Related U.S. Application Data
(63) Continuation-in-part of application No. 12/234,591, filed on Sep. 19, 2008.
(60) Provisional application No. 61/220,130, filed on Jun. 24, 2009.

(51) Int. Cl. G06F 19/00

(52) U.S. Cl. 701/22

(57) ABSTRACT

A system and method for managing energy usage in an electric vehicle. A charge level of at least one battery of the electric vehicle is received. A current location of the electric vehicle is received. A theoretical maximum range of the electric vehicle is determined based on the current location of the electric vehicle and the charge level of the at least one battery of the electric vehicle. An energy plan for the electric vehicle is generated

### RELATED APPLICATIONS

This application is a continuation-in-part of U.S. patent application Ser. No. 12/234,591, filed on Sep. 19, 2008, which application is incorporated by reference herein in its entirety. This application also claims the benefit of U.S. Provisional Patent Application No. 61/220,130, filed on Jun. 24, 2009, which application is incorporated by reference herein in its entirety.

### TECHNICAL FIELD

The disclosed embodiments relate generally to electric vehicles. More particularly, the disclosed embodiments relate to systems and methods for operating an electric vehicle.

### BACKGROUND

Electric vehicles provide the promise of reducing dependence on foreign sources of fossil fuels and reducing pollution associated with the burning of these fossil fuels. Unfortunately, using present battery technologies, electric vehicles have a substantially shorter range than fossil fuel-based vehicles and the batteries require many hours to recharge. Thus, it is difficult for drivers of electric vehicles to go on trips longer than the range provided by a single charge of the batteries of the electric vehicle without spending a substantial amount of time recharging the batteries of the electric vehicle. Furthermore, the range of the electric vehicle may also be affected by environmental factors (e.g., terrain, temperature, etc.), driving style, traffic, etc. Thus, it is difficult for a driver of an electric vehicle to plan a trip as the driver currently has no way of knowing whether the electric vehicle will be able to reach the destination based on the existing charge of the batteries of the electric vehicle. These drawbacks render electric vehicles inconvenient and impractical. Accordingly, it would be highly desirable to provide an electric vehicle that addresses the above described drawbacks.

### SUMMARY

Some embodiments provide a system, a computer readable storage medium including instructions, and a computer-implemented method for managing energy usage in an at least partially electric vehicle. A charge level of at least one battery of the at least partially electric vehicle is received. A current location of the at least partially electric vehicle is received. A theoretical maximum range of the at least partially electric vehicle is determined based on the current location of the at least partially electric vehicle and the charge level of the at least one battery of the at least partially electric vehicle. A geographic map including the current location of the at least partially electric vehicle is displayed on a display device of the at least partially electric vehicle. A first boundary is displayed on the geographic map indicating the maximum theoretical range of the at least partially electric vehicle.

In some embodiments, one or more visual indicators are displayed on the geographic map to indicate that locations outside of the first boundary are unreachable by the at least partially electric vehicle based at least in part on the current location and the theoretical maximum range of the at least partially electric vehicle.

In some embodiments, a second boundary that is a predetermined distance from a reference point is determined, wherein the predetermined distance is the farthest destination that the at least partially electric vehicle can travel to and still be able to return to the reference point. The second boundary is then displayed on the geographic map.

In some embodiments, the reference point is the point at which the at least partially electric vehicle spends the most time charging the at least one battery of the at least partially electric vehicle.

In some embodiments, the reference point is selected from the group consisting of a home of a user of the at least partially electric vehicle and an office of a user of the at least partially electric vehicle.

In some embodiments, an energy plan for the at least partially electric vehicle is generated.

In some embodiments, the energy plan includes one or more routes, a destination, and one or more battery service stations at which the at least one battery may be serviced.

In some embodiments, the energy plan for the at least partially electric vehicle is generated as follows. It is determined whether the at least partially electric vehicle can reach a predefined location based on the theoretical maximum range. In response to determining that the at least partially electric vehicle cannot reach the predefined location, a battery service station within the theoretical maximum range of the current location of the at least partially electric vehicle at which the at least one battery of the at least partially electric vehicle may be serviced is determined. The battery service station is added to the energy plan.

In some embodiments, time is scheduled at the battery service station to service the at least one battery of the at least partially electric vehicle after adding a battery service station to the energy plan.

In some embodiments, time is scheduled at the battery service station to service the at least one battery of the at least partially electric vehicle based on an estimated time that the at least partially electric vehicle will arrive at the battery service station.

In some embodiments, the predefined location is selected from the group consisting of a home of the user, a workplace of the user, and a location where the at least partially electric vehicle is charged.

In some embodiments, in response to determining that the at least partially electric vehicle can reach the predefined location, the operations of receiving a charge level of at least one battery of the at least partially electric vehicle, receiving a current location of the at least partially electric vehicle, determining a theoretical maximum range of the at least partially electric vehicle based on the current location of the at least partially electric vehicle and the charge level of the at least one battery of the at least partially electric vehicle, displaying on the display device a geographic map including the current location of the at least partially electric vehicle, and displaying a first boundary on the geographic map indicating the maximum theoretical range of the at least partially electric vehicle is repeated.

In some embodiments, a route from the current location of the at least partially electric vehicle to the battery service station is generated and is added to the energy plan.

In some embodiments, the battery service station is selected from the group consisting of charge stations that recharge the one or more battery packs of the vehicle, battery exchange stations that replace a spent battery of the vehicle with a charged battery, and any combination of the aforementioned battery service stations.

In some embodiments, the predefined location is selected from the group consisting of a user-specified destination, a battery service station, a destination determined based on a user profile, and a destination determined based on aggregate user profile data.

In some embodiments, the theoretical maximum range of the at least partially electric vehicle is determined after the at least one battery is serviced at the battery service station. It is determined whether the at least partially electric vehicle can reach the predefined location based on the theoretical maximum range. In response to determining that the at least partially electric vehicle cannot reach the predefined location, a next battery service station within the theoretical maximum range of a previous battery service station in the energy plan and on a route to the predefined location is determined. The next battery service station is added to the energy plan. The aforementioned operations in these embodiments are repeated until the predefined location is reachable.

In some embodiments, a route from the current location of the at least partially electric vehicle to the destination is generated, wherein the route includes stops at the battery service stations in the energy plan. The route is added to the energy plan.

In some embodiments, in response to determining that the at least partially electric vehicle can reach the destination, a route from the current location of the at least partially electric vehicle to the destination is generated is added to the energy plan.

In some embodiments, the theoretical maximum range is based at least in part on the charge level of the at least one battery of the at least partially electric vehicle, the current location of the at least partially electric vehicle, a profile of the user, properties of at least one electric motor of the at least partially electric vehicle, types of terrain on which roads are situated, a speed of the at least partially electric vehicle, any combination of the aforementioned elements.

In some embodiments, the theoretical maximum range is adjusted to provide a margin of safety.

In some embodiments, it is determined whether a silent navigation mode is enabled. In response to determining that the silent navigation mode is not enabled, guidance based on the energy plan is provided.

In some embodiments, in response to determining that the silent navigation mode is enabled, guidance based on the energy plan is disabled.

In some embodiments, the guidance includes turn-by-turn guidance.

In some embodiments, the guidance is selected from the group consisting of visual guidance, audio guidance, and any combination of the aforementioned guidance.

In some embodiments, the current location of the at least partially electric vehicle is received from a global satellite navigation system.

In some embodiments, an energy plan for the at least partially electric vehicle is received. Guidance based on the energy plan is provided. It is periodically determined whether the energy plan is still valid.

In some embodiments, a request to service the at least one battery of the at least partially electric vehicle is received at a computer system remote from the at least partially electric vehicle. In response to the request, a service plan to service the at least one battery of the at least partially electric vehicle is generated.

In some embodiments, a request to service the at least one battery of the at least partially electric vehicle is transmitted to a server. In response to the request, a service plan is received from the server. The service plan is then managed.

In some embodiments, the service plan indicates that the at least one battery of the at least partially electric vehicle is to be exchanged for at least one charged battery. In these embodiments, the exchanging of the at least one battery for the at least one charged battery is facilitated.

Some embodiments provide a system, a computer readable storage medium including instructions, and a computer-implemented method for providing energy-aware navigation services to an electric vehicle. An energy plan for the electric vehicle is received. Guidance based on the energy plan is provided. Periodically, it is determined whether the energy plan is still valid.

In some embodiments, in response to determining that the energy plan is no longer valid, a new energy plan is generated and guidance based on the new energy plan is provided.

In some embodiments, in response to determining that the energy plan is still valid, guidance based on the energy plan is continued. Periodically, it is determined whether the energy plan is still valid.

In some embodiments, it is determined whether the energy plan is still valid as follows. A charge level of at least one battery of the electric vehicle and a current location of the electric vehicle are received. It is determined whether a waypoint in the energy plan is reachable based at least in part on the current location of the electric vehicle and the charge level of the at least one battery.

In some embodiments, the energy plan includes one or more waypoints.

In some embodiments, a waypoint is selected from the group consisting of a home of the user, a workplace of the user, a location where the electric vehicle is charged, a user-specified destination, a battery service station, a destination determined based on a user profile, and a destination determined based on aggregate user profile data.

In some embodiments, it is determined that a waypoint in the energy plan has been reached. It is then determined that the waypoint is a battery service station. It is then determined that at least one battery of the electric vehicle was serviced at the battery service station. Information about services performed on the at least one battery of the electric vehicle is recorded.

In some embodiments, the information about the services performed on the at least one battery is transmitted to a server.

In some embodiments, the guidance includes turn-by-turn guidance.

In some embodiments, the guidance is selected from the group consisting of visual guidance, audio guidance, and any combination of the aforementioned guidance.

Some embodiments provide a system, a computer readable storage medium including instructions, and a computer-implemented method for servicing a battery of an electric vehicle at a battery service station. A request to service at least one battery of the electric vehicle is received. In response to the request, a service plan to service the at least one battery of the electric vehicle is generated.

In some embodiments, the service plan is transmitted to the electric vehicle.

In some embodiments, the service plan is transmitted to the battery service station.

In some embodiments, the request is received from a battery service station.

In some embodiments, the request is received from the electric vehicle.

In some embodiments, the request includes battery identifiers for the battery packs, types of the battery packs, a user identifier, a vehicle identifier, and charge levels of the battery packs.

In some embodiments, the service plan is selected from the group consisting of a charge plan for recharging the battery packs of the electric vehicle, a battery exchange plan for exchanging the battery packs of the electric vehicle, and any combination of the aforementioned plans.

Some embodiments provide a system, a computer readable storage medium including instructions, and a computer-implemented method for servicing a battery of an electric vehicle at a battery service station. In some embodiments, a request to service at least one battery of the electric vehicle is transmitted to a server. In response to the request, a service plan is received from the server. The service plan is then managed.

In some embodiments, the request includes battery identifiers for the battery packs, types of the battery packs, a user identifier, a vehicle identifier, and charge levels of the battery packs.

In some embodiments, the battery service station is a battery exchange station and the service plan is managed as follows. It is determined that the at least one battery of the electric vehicle is supported by a platform of the battery exchange station. Battery locks that prevent the at least one battery from being decoupled from a battery bay of the electric vehicle are disengaged. The at least one battery is decoupled from the battery bay of the electric vehicle. It is determined that at least one new battery is ready to be coupled to the battery bay of the electric vehicle. The at least one new battery is coupled to the battery bay of the electric vehicle. The battery locks are then engaged.

In some embodiments, the battery service station is a charge station and the service plan is managed as follows. A charge level of the at least one battery of the electric vehicle is periodically determined. The charge level of the at least one battery of the electric vehicle is periodically transmitted to the charge station. Energy is received from the charge station based at least in part on the service plan and the charge level of the at least one battery.

In some embodiments, a report of the energy used is received from the charge station.

In some embodiments, the report is transmitted to a server.

In some embodiments, the charge level is transmitted to a mobile device of a user of the electric vehicle.

In some embodiments, the charge level is transmitted to a server.

Some embodiments provide a system, a computer readable storage medium including instructions, and a computer-implemented method for providing value-added services to an electric vehicle. A selected search result is received from a user of the electric vehicle. Offers with a specified distance of the selection are determined. The offers are then presented to the user in a user interface of the electric vehicle.

In some embodiments, a search query is selected from the group consisting of a point of interest, an address, a product, a service, and any combination of the aforementioned search queries.

In some embodiments, an offer is selected from the group consisting of a coupon, a sale price, promotional discount, and any combination of the aforementioned offers.

In some embodiments, prior to receiving the selected search result from the user, the following operations are performed. A search query from a user of the electric vehicle is received. Search results based on the search query are retrieved. The search results are presented to the user in the user interface of the electric vehicle.

In some embodiments, after presenting the offers, tracking information is sent to a server.

In some embodiments, a selected offer is received from the user of the electric vehicle. An energy plan for the electric vehicle is generated. Guidance based on the energy plan is provided.

In some embodiments, the guidance includes turn-by-turn guidance.

In some embodiments, the guidance is selected from the group consisting of visual guidance, audio guidance, and any combination of the aforementioned guidance.

In some embodiments, after receiving the selected offer from the user, tracking information is sent to the server.

In some embodiments, it is determined that the electric vehicle has reached a destination associated with the selected offer. Tracking information is then sent to the server.

### BRIEF DESCRIPTION OF THE DRAWINGS

FIG. 1 is a block diagram illustrating an electric vehicle network, according to some embodiments.

FIG. 2 is a block diagram illustrating components of an electric vehicle, according to some embodiments.

FIG. 3 is a block diagram illustrating an electric vehicle control system, according to some embodiments.

FIG. 4 is a flow diagram of a method for providing energy-aware navigation services for an electric vehicle, according to some embodiments.

FIG. 5 is a flow diagram of a method for managing energy usage for an electric vehicle when a destination has been specified, according to some embodiments.

FIG. 6 is a flow diagram of a method for generating an energy plan from a current location of an electric vehicle to a destination, according to some embodiments.

FIG. 7A illustrates an exemplary user interface of the electric vehicle displaying a map and a route for the electric vehicle, according to some embodiments.

FIG. 7B illustrates another exemplary user interface of the electric vehicle displaying a map and a first route for the electric vehicle, according to some embodiments.

FIG. 7C illustrates the user interface of FIG. 7B displaying the map and a second route for the electric vehicle, according to some embodiments.

FIG. 7D illustrates another exemplary user interface of the electric vehicle displaying a map and a destination for the electric vehicle, according to some embodiments.

FIG. 7E illustrates the user interface of FIG. 7D displaying the map and a first route for the electric vehicle, according to some embodiments.

FIG. 7F illustrates the user interface of FIG. 7D displaying the map and a second route for the electric vehicle, according to some embodiments.

FIG. 7G illustrates the user interface of FIG. 7D displaying the map and a third route for the electric vehicle, according to some embodiments.

FIG. 7H illustrates the user interface of FIG. 7D displaying the map and the route to the destination for the electric vehicle, according to some embodiments.

FIG. 8 is a flow diagram of a method for managing energy usage for an electric vehicle when a destination has not been selected, according to some embodiments.

FIG. 9 illustrates an exemplary user interface of the electric vehicle displaying a map and reachable destinations for the electric vehicle, according to some embodiments.

FIG. 10 is a flow diagram of a method for executing an energy plan, according to some embodiments.

FIG. 11 is a flow diagram of a method for providing “silent navigation,” according to some embodiments.

FIG. 12 is a flow diagram of a method for determining whether an electric vehicle is out-of-range of a battery service station, according to some embodiments.

FIG. 13 is a flow diagram of a method for monitoring routes traveled by an electric vehicle, according to some embodiments.

FIG. 14 is a flow diagram of a method for monitoring charge levels of battery packs of an electric vehicle, according to some embodiments.

FIG. 15 is a flow diagram of a method for servicing a battery of an electric vehicle, according to some embodiments.

FIG. 16 is a flow diagram of a method for servicing a battery of an electric vehicle at a battery exchange station, according to some embodiments.

FIG. 17 is a flow diagram of a method for servicing a battery of an electric vehicle at a charge station, according to some embodiments.

FIG. 18 is a block diagram illustrating data and energy flows for an electric vehicle being charged at a public charge station, according to some embodiments.

FIG. 19 is a block diagram illustrating data and energy flows for an electric vehicle being charged at a public charge station, according to some embodiments.

FIG. 20 is a block diagram illustrating data and energy flows for an electric vehicle being charged at a home charge station, according to some embodiments.

FIG. 21 is a block diagram illustrating data and energy flows for an electric vehicle being charged at a home charge station, according to some embodiments.

FIG. 22 is a flow diagram of a method for providing value-added services to an electric vehicle, according to some embodiments.

Like reference numerals refer to corresponding parts throughout the drawings.

### DESCRIPTION OF EMBODIMENTS

### Electric Vehicle

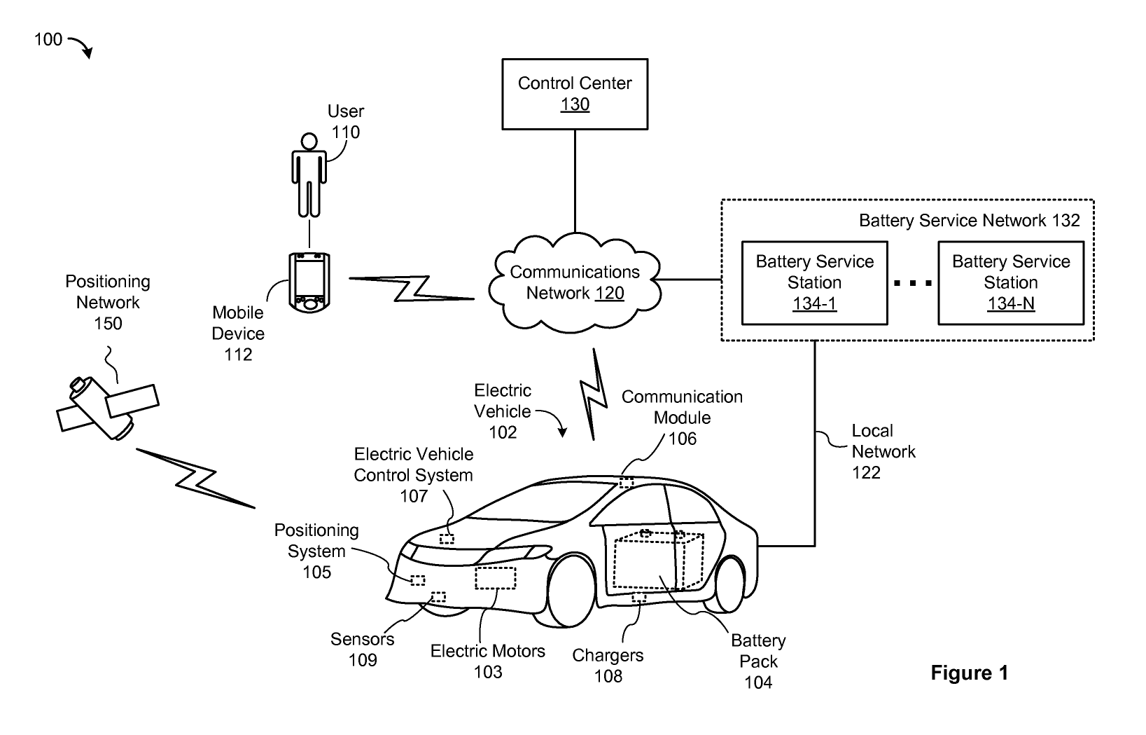

FIG. 1 is a block diagram of an electric vehicle network 100, according to some embodiments. As illustrated in FIG. 1, the electric vehicle network 100 includes at least one electric vehicle 102 having one or more electric motors 103, one or more battery packs 104 each including one or more batteries, a positioning system 105, a communication module 106, an electric vehicle control system 107, one or more chargers 108, one or more sensors 109, and any combination of the aforementioned components.

In some embodiments, the one or more electric motors 103 drive one or more wheels of the electric vehicle 102. In these embodiments, the one or more electric motors 103 receive energy from one or more battery packs 104 that is electrically and mechanically attached to the electric vehicle 102. The one or more battery packs 104 of the electric vehicle 102 may be charged at a home of a user 110. Alternatively, the one or more battery packs 104 may be serviced (e.g., exchanged and/or charged, etc.) at a battery service station 134 (e.g., battery service stations 134-1 to 134-N) within a battery service network 132. The battery service stations 134 may include charge stations for charging the one or more battery packs 104, battery exchange stations for exchanging the one or more battery packs 104, or the like (e.g., see U.S. patent application Ser. No. 12/428,932, which is hereby incorporated by reference in its entirety). For example, the one or more battery packs 104 of the electric vehicle 102 may be charged at one or more charge stations, which may be located on private property (e.g., the home of the user 110, etc.) or on public property (e.g., parking lots, curbside parking, etc.). Furthermore, in some embodiments, the one or more battery packs 104 of the electric vehicle 102 may be exchanged for charged battery packs at one or more battery exchange stations within the battery service network 132. Thus, if a user is traveling a distance beyond the range of a single charge of the one or more battery packs 104 of the electric vehicle 102, the spent (or partially spent) battery packs may be exchanged for charged battery packs so that the user can continue with his/her travels without waiting for the battery pack to be recharged. The term “battery service station” (e.g., the battery service stations 134) is used herein to refer to battery exchange stations, which exchange spent (or partially spent) battery packs of the electric vehicle for charged battery packs, and/or charge stations, which provide energy to charge a battery pack of an electric vehicle. Furthermore, the term “charge spot” may also be used herein to refer to a “charge station.”

In some embodiments, the electric vehicle 102 communicates with the battery service station 134 via the communication module 106, the communications network 120, and a control center 130. In some embodiments, while the one or more battery packs 104 of the electric vehicle 102 is being serviced by a battery service station, the electric vehicle 102 communicates with the battery service station 134-1 via the communications network 120. In some embodiments, while the one or more battery packs 104 of the electric vehicle 102 are being serviced (e.g., exchanged or charged) at a battery service station, the electric vehicle 102 communicates with the battery service station 134 directly. For example, the electric vehicle 102 may communicate with the battery service station 134-1 via a local network 122 (e.g., wired or wireless).

The communications network 120 may include any type of wired or wireless communication network capable of coupling together computing nodes. This includes, but is not limited to, a local area network, a wide area network, or a combination of networks. In some embodiments, the communications network 120 is a wireless data network including: a cellular network, a Wi-Fi network, a WiMAX network, an EDGE network, a GPRS network, an EV-DO network, an RTT network, a HSPA network, a UTMS network, a Flash-OFDM network, an iBurst network, and any combination of the aforementioned networks. In some embodiments, the communications network 120 includes the Internet.

In some embodiments, the electric vehicle 102 includes the positioning system 105. The positioning system 105 may include: a satellite positioning system, a radio tower positioning system, a Wi-Fi positioning system, and any combination of the aforementioned positioning systems. The positioning system 105 is used to determine the geographic location of the electric vehicle 102 based on information received from a positioning network 150. The positioning network 150 may include: a network of satellites in a global satellite navigation system (e.g., GPS, GLONASS, Galileo, etc.), a network of beacons in a local positioning system (e.g., using ultrasonic positioning, laser positioning, etc.), a network of radio towers, a network of Wi-Fi base stations, and any combination of the aforementioned positioning networks. Furthermore, the positioning system 105 may include a navigation system that generates routes and/or guidance (e.g., turn-by-turn or point-by-point, etc.) between a current geographic location of the electric vehicle and a destination.

In some embodiments, the electric vehicle 102 includes the communication module 106, including hardware and software, that is used to communicate with the control center 130 (e.g., a service provider) and/or other communication devices via a communications network (e.g., the communications network 120).

In some embodiments, the electric vehicle 102 includes the electric vehicle control system 107. The electric vehicle control system 107 may provide services including: energy-aware navigation, energy management, value-added services, account management, battery service management, and any combination of the aforementioned services. These services are described in more detail below.

In some embodiments, the electric vehicle control system 107 provides information about the present status of the electric vehicle 102 to a mobile device 112 (e.g., a mobile phone, a personal digital assistant (PDA), a laptop computer, etc.) of the user 110. For example, the status information may include the present charge level of the one or more battery packs 104, whether charging has completed, etc. This status information may also be provided via an on-board display screen.

In some embodiments, the electric vehicle 102 includes the one or more chargers 108 that are configured to charge the one or more battery packs 104. In some embodiments, the one or more chargers 108 are conductive chargers that receive energy from an energy source via conductive coupling (e.g., a direct electrical connection, etc.). In some embodiments, the one or more chargers 108 are inductive chargers that receive energy from an energy source via inductive coupling. In some embodiments, the electric vehicle 102 does not include the one or more chargers. In these embodiments, the charge stations include the one or more chargers.

In some embodiments, the electric vehicle 102 includes the one or more sensors 109. The one or more sensors 109 may include mechanical sensors (e.g., accelerometers, pressure sensors, etc.), electromagnetic sensors (e.g., magnetometers, voltage sensors, current sensors, etc.), optical sensors (e.g., light, infrared, ultraviolet, etc.), acoustic sensors, temperature sensors, etc. In some embodiments, the one or more sensors 109 are used to detect whether the one or more battery packs 104 are mechanically and/or electrically coupled to the electric vehicle 102. In some embodiments, the one or more sensors 109 are used to detect whether a charging mechanism (e.g., a charge cord, etc.) is mechanically and/or electrically coupled to the electric vehicle 102.

In some embodiments, the control center 130 periodically provides a list of suitable service stations (e.g., within the maximum theoretical range of the electric vehicle, has the correct type of battery packs, etc.) and respective status information to the electric vehicle 102 via the communications network 120. The status of a battery service station may include: a number of charge stations of the respective battery service station that are occupied, a number of suitable charge stations of the respective battery service station that are free, an estimated time until charge completion for respective vehicles charging at respective charge stations, a number of suitable battery exchange bays of the respective battery service station that are occupied, a number of suitable battery exchange bays of the respective battery service station that are free, a number of suitable charged battery packs available at the respective battery service station, a number of spent battery packs at the respective battery service station, the types of battery packs available at the respective battery service station, an estimated time until a respective spent battery is recharged, an estimated time until a respective exchange bay will become free, a location of the battery service station, battery exchange times, and any combination of the aforementioned statuses.

In some embodiments, the control center 130 also provides access to the battery service stations to the electric vehicle 102. For example, the control center 130 may instruct a charge station to provide energy to recharge the one or more battery packs 104 after determining that an account for the user 110 allows the user 110 to receive energy from the charge station. Similarly, the control center 130 may instruct a battery exchange station to commence the battery exchange process after determining that the account for the user 110 allows the user 110 to receive a fresh battery pack from the battery exchange station (e.g., the account for the user 110 is in good standing). Furthermore, the control center 130 may reserve time at a battery exchange station and/or a charge station. The control center 130 obtains information about the electric vehicles and/or battery service stations by sending queries through the communications network 120 to the electric vehicle 102 and to the battery service stations 134 (e.g., charge stations, battery exchange stations, etc.) within the battery service network 132. For example, the control center 130 can query the electric vehicle 102 to determine a geographic location of the electric vehicle and a status of the one or more battery packs 104 of the electric vehicle 102. Similarly, the control center 130 may query the battery service stations 134 to determine the status of the battery service stations 134. The control center 130 may also send information and/or commands through the communications network 120 to the electric vehicle 102 and the battery service stations 134. For example, the control center 130 may send information about a status of an account of the user 110, the locations of battery service stations, and/or a status of the battery service stations.

In some embodiments, the battery service stations 134 provide status information to the control center 130 via the communications network 120 directly (e.g., via a wired or wireless connection using the communications network 120). In some embodiments, the battery service network 132 includes a separate communication network (e.g., via a wired or wireless connection to the battery service network 132) coupling each of the battery service stations 134 to one or more servers of the battery service network 132. In these embodiments, the battery service stations 134 provide status information to the one or more servers of the battery service network, which in turn transmits the status information to the control center 130 via the communications network 120.

In some embodiments, the information transmitted between the battery service stations 134 and the control center 130 are transmitted in real-time. In some embodiments, the information transmitted between the battery service stations 134 and the control center 130 are transmitted periodically.

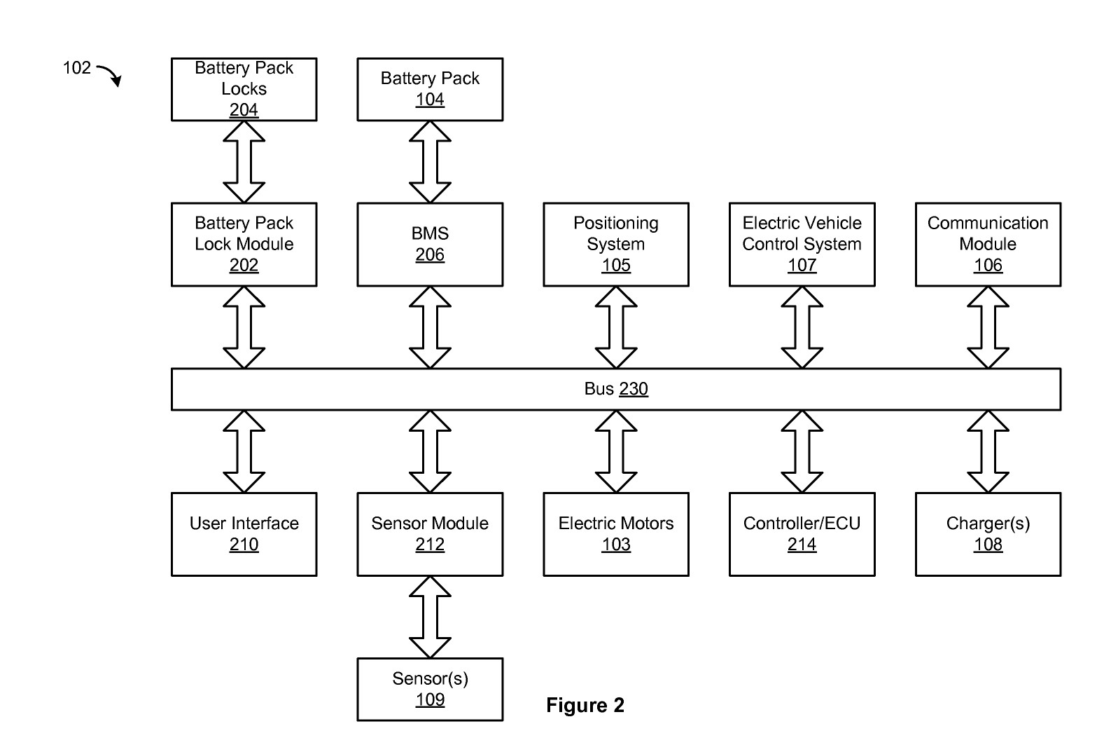

FIG. 2 is a block diagram illustrating components of the electric vehicle 102, according to some embodiments. The electric vehicle 102 includes a battery management system (BMS) 206, the positioning system 105, the electric vehicle control system 107, the communication module 106, a sensor module 212, one or more electric motors 103, a controller or engine control unit (ECU) 214, the one or more chargers 108, the one or more battery packs 104, a battery pack lock module 202, a user interface 210, one or more battery pack locks 204, the one or more sensors 109, and any combination of the aforementioned components. Note that while individual blocks are shown, these blocks may be separate or combined.

In some embodiments, the BMS 206, the positioning system 105, the electric vehicle control system 107, the communication module 106, the sensor module 212, the one or more electric motors 103, the controller/ECU 214, the one or more chargers 108, the battery pack lock module 202, and the user interface 210 all communicate with each other via a bus 230. In some embodiments, the bus 230 is a controller area network bus (CAN-bus). In some embodiments, a subset of these components communicate with each other via a separate connection (e.g., another bus, a direct connection, a wireless connection, etc.). In some embodiments, the one or more battery packs 104 communicate with the BMS 206 via a separate connection (e.g., another bus, direct connection, a wireless connection, etc.). In some embodiments, the battery pack lock module 202 communicates with the one or more battery pack locks 204 via a separate connection (e.g., another bus, direct connection, a wireless connection, etc.). In some embodiments, the sensor module 212 communicates with the one or more sensors 109 via a separate connection (e.g., another bus, direct connection, a wireless connection, etc.).

In some embodiments, the BMS 206 includes circuitry configured to manage the operation and/or monitor the state of one or more batteries of the one or more battery packs 104. The circuitry may include state-monitoring circuitry configured to monitor the state of the one or more battery packs 104 (e.g., voltage meters, current meters, temperature sensors, etc.). For example, the state-monitoring circuitry may determine the present voltage output, current draw, and/or the temperature of the one or more battery packs 104. The circuitry may also include one or more processors, memory, and communication interfaces. The communication interfaces may be configured to send and receive data and/or commands to/from other components on the bus 230. The memory of the BMS 206 may include programs, modules, data structures, or a subset thereof that manage the operation and/or monitor the state of the one or more battery packs. The programs and/or modules may be stored in the memory of the BMS 206 and correspond to a set of instructions for performing the operations described herein when executed by the one or more processors of the BMS 206. The one or more processors of the BMS 206 may be configured to receive state data from the state-monitoring circuitry and to perform specified operations on the state data to determine the status of the one or more battery packs 104. For example, the one or more processors of the BMS 206 may execute instructions stored in the memory of the BMS 206 to determine the present charge levels of the one or more battery packs 104 based on the state data received from the state-monitoring circuitry. The one or more processors of the BMS 206 may also be configured to receive commands from other components on the bus 230 and to perform specified operations on the one or more battery packs 104 based on the received commands and the data received from the one or more battery packs 104. For example, the one or more processors of the BMS 206 may receive commands from the controller/ECU 214 via the bus 230 to determine whether the one or more battery packs 104 are operating within normal operating conditions. The one or more processors of the BMS 206 may then execute instructions stored in the memory of the BMS 206 to make this determination and to perform specified actions if the normal operating conditions are exceeded (e.g., reducing the current draw from the one or more battery packs 104).

In some embodiments, the positioning system 105 includes circuitry configured to receive signals from a positioning network (e.g., the positioning network 150 in FIG. 1) and to determine the current location of the electric vehicle 102 based on the received signals. The circuitry may include antennas (e.g., discrete or integrated, etc.), signal amplification circuits, signal processing circuitry, etc. The circuitry may also include one or more processors, memory, and communication interfaces. The communication interfaces may be configured to send and receive data and/or commands to/from other components on the bus 230. The memory of the positioning system 105 may include programs, modules, data structures, or a subset thereof that determines the current location of the electric vehicle 102 based on the signals received from the positioning network. The programs and/or modules may be stored in the memory of the positioning system 105 and correspond to a set of instructions for performing the operations described herein when executed by the one or more processors of the positioning system 105. For example, the positioning system 105 may receive global positioning signals from a plurality of global navigation satellites. The processor of the positioning system 105 may then execute programs stored in the memory of the positioning system 105 to calculate the position of the electric vehicle 102 based on the received signals. The processor of the positioning system 105 may then use the communication interfaces of the positioning system 105 to transmit the calculated position to other components of the electric vehicle 102 via the bus 230.

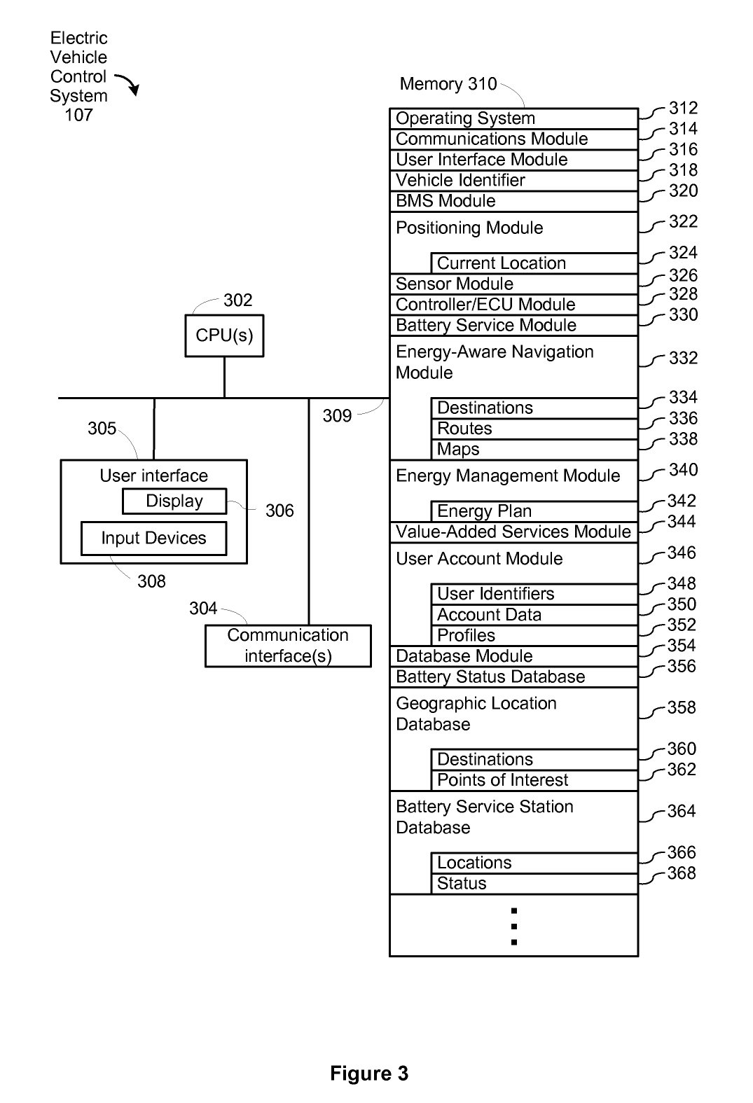

The electric vehicle control system 107 is described in more detail with respect to FIGS. 3-22 below.

In some embodiments, the communication module 106 includes circuitry configured to send and/or receive data and/or commands to/from other devices external to the electric vehicle 102. The circuitry may include antennas (e.g., discrete or integrated, etc.), signal amplification circuits, signal processing circuitry, etc. The circuitry may also include one or more processors, memory, and communication interfaces. The communication interfaces may be configured to send and receive data and/or commands to/from other components on the bus 230. The memory of the communication module 106 may include programs, modules, data structures, or a subset thereof that sends and/or receives data and/or commands to devices external to the electric vehicle 102. The programs and/or modules may be stored in the memory of the communication module 106 and correspond to a set of instructions for performing the operations described herein when executed by the one or more processors of the communication module 106. For example, the communication module 106 may receive data representing the battery status from the BMS 206 via the bus 230. The communication module 106 may then execute programs stored in the memory of the communication module 106 to packetize and to transmit the data representing the battery status to a device external to the electric vehicle 102 (e.g., the control center 130 in FIG. 1, etc.). In some embodiments the battery status of a battery pack includes a unique identifier of the battery pack, a manufacturer of the battery pack, a model number of the battery pack, a charge level of the battery pack, an age of the battery pack, the number of charge/discharge cycles of the battery pack, and a combination of the aforementioned statuses.

In some embodiments, the sensor module 212 includes circuitry configured to receive sensor signals from the one or more sensors 109 and to preprocess the received signals (e.g., convert the signals from analog to digital form, amplify, filter, etc.). In some embodiments, the one or more sensors 109 include mechanical sensors (e.g., accelerometers, pressure sensors, gear position sensors, handbrake position sensors, door lock sensors, air conditioning sensors, or other vehicle sensors, etc.), electromagnetic sensors (e.g., magnetometers, voltage sensors, current sensors, etc.), optical sensors (e.g., light, infrared, ultraviolet, etc.), acoustic sensors, temperature sensors, etc. The circuitry may include signal amplification circuits, signal processing circuitry, etc. The circuitry may also include one or more processors, memory, and communication interfaces. The communication interfaces may be configured to send and receive data and/or commands to/from other components on the bus 230 and/or to the one or more sensors 109. The memory of the sensor module 212 may include programs, modules, data structures, or a subset thereof that preprocesses the signals received from the one or more sensors 109. The programs and/or modules may be stored in the memory of the sensor module 212 and correspond to a set of instructions for performing the operations described herein when executed by the one or more processors of the sensor module 212. For example, the sensor module 212 may receive temperature signals from temperature sensors of the electric vehicle 102. The circuitry of the sensor module 212 may then amplify and/or filter the signals. The processor of the sensor module 212 may also execute instructions stored in the memory of the sensor module 212 to perform specified operations (e.g., calculate a running average, store the temperature data, etc.). The processor of the sensor module 212 may then use the communication interfaces of the sensor module to transmit the results of the specified operations to other components on the bus 230.

In some embodiments, the controller/ECU 214 includes circuitry configured to manage the operation and/or monitor the state of the one or more electric motors 103. The circuitry may include one or more processors, memory, and/or communication interfaces. The communication interfaces may be configured to send and receive data and/or commands to/from other components on the bus 230. The memory of the controller/ECU 214 may include programs, modules, data structures, and/or a subset thereof that manage the operation and/or monitor the state of the one or more electric motors 103. The programs and/or modules may be stored in the memory of the controller/ECU 214 and correspond to a set of instructions for performing the operations described herein when executed by the one or more processors of the controller/ECU 214. For example, the one or more processors of the controller/ECU 214 may receive various sensor measurements from the one or more sensors 109 (e.g., a throttle position sensor, etc.) via the bus 230. The one or more processors of the controller/ECU 214 may then execute instructions stored in the memory of the controller/ECU 214 to monitor and regulate the speed of the one or more electric motors 103 based on the received sensor measurements (e.g., throttle position, etc.).

In some embodiments, the one or more chargers 108 include circuitry configured to receive energy from an energy source, regulate, and/or transform the energy so that the energy can be transferred to the one or more battery packs 104. The circuitry may also include one or more processors, memory, and communication interfaces. The communication interfaces may be configured to send and receive data and/or commands to/from other components on the bus 230. The memory of the one or more chargers 108 may include programs, modules, data structures, or a subset thereof that manage and/or monitor the charging process. The programs and/or modules may be stored in the memory of the one or more chargers 108 and correspond to a set of instructions for performing the operations described herein when executed by the one or more processors of the one or more chargers 108. For example, the processor of the one or more chargers 108 may receive data indicating that the one or more battery packs 104 are almost fully charged from the BMS 206 via the bus 230. In response to the received data, the processors of the one or more chargers 108 may execute programs stored in the memory of the one or more chargers 108 to regulate the energy transfer and to terminate the charging process when the one or more battery packs 104 are fully charged to prevent overcharging of the one or more battery packs 104.

In some embodiments, the battery pack lock module 202 includes circuitry configured to engage and/or disengage the one or more battery pack locks 204 so that the one or more battery packs 104 may be coupled/decoupled to the frame or chassis of the electric vehicle 102. The circuitry may also include one or more processors, memory, and/or communication interfaces. The communication interfaces may be configured to send and receive data and/or commands to/from other components on the bus 230. The memory of the battery pack lock module 202 may include programs, modules, data structures, or a subset thereof that manage the coupling/decoupling of the one or more battery packs 104 from the chassis of the electric vehicle 102. The programs and/or modules may be stored in the memory of the battery pack lock module 202 and correspond to a set of instructions for performing the operations described herein when executed by the one or more processors of the battery pack lock module 202. For example, the electric vehicle control system 107 may send commands to the battery pack lock module 202 via the bus 230 instructing the battery pack lock module 202 to disengage the one or more battery pack locks 204 of the one or more battery packs 104. The processor of the battery pack lock module 202 may then execute instructions stored in the memory of the battery pack lock module 202 to perform operations that release the one or more battery pack locks 204 (e.g., sending signals to motors coupled to the one or more battery pack locks 204 so that the motors will release the locks, etc.)

In some embodiments, the user interface 210 includes input and output devices. For example, the input devices may include a mouse, a keyboard, a touchpad, a rotary joystick or knob, a touch screen display, microphones, a speech-recognition and/or command system, and the like, and the output devices may include a display screen, a touch screen display, a heads up display, dashboard indicators, audio speakers, a speech-synthesis system, and the like, and input devices. The user interface 210 may send and/or receive data and/or commands via the bus 230 to other components on the bus 230.

In some embodiments, a subset of the aforementioned components of the electric vehicle 102 may be combined with the electric vehicle control system 107. For example, the positioning system 105, the communication module 106, the sensor module 212, the battery pack lock module 202, and the user interface 210 may be included with the electric vehicle control system 107.

FIG. 3 is a block diagram illustrating an electric vehicle control system 107 in accordance with some embodiments. The electric vehicle control system 107 typically includes one or more processing units (CPU's) 302, one or more networks or other communications interfaces 304 (e.g., antennas, I/0 interfaces, etc.), memory 310, and one or more communication buses 309 for interconnecting these components (e.g., the bus 230 in FIG. 2, etc.). The communication buses 309 may include circuitry (sometimes called a chipset) that interconnects and controls communications between system components. The electric vehicle control system 107 optionally may include a user interface 305 comprising a display device 306, input devices 308 (e.g., a mouse, a keyboard, a touchpad, a touch screen, microphone, etc.), and speakers. The memory 310 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 310 may optionally include one or more storage devices located remotely from the CPU(s) 302. The memory 310, comprises a computer readable storage medium. In some embodiments, the memory 310 stores the following programs, modules and data structures, or a subset thereof:
an operating system 312 that includes procedures for handling various basic system services and for performing hardware dependent tasks (e.g., Windows, Linux, or the like);
a communication module 314 that is used for connecting the electric vehicle control system 107 to a bus of an electric vehicle (e.g., the bus 230 of the electric vehicle 102, etc.), to other computers or devices, and/or to one or more communication networks, such as the Internet, other wide area networks, local area networks, metropolitan area networks, and so on, via the one or more communication network interfaces 304 (wired or wireless);
a user interface module 316 that receives commands from a user via the input devices 308 and generates user interface objects to be displayed on the display device 306;
a vehicle identifier 318 that uniquely identifies the electric vehicle 102;
a BMS module 320 that receives battery status data from a BMS (e.g., the BMS 206 in FIG. 2) on the bus of the electric vehicle (e.g., the bus 230 in FIG. 2) and transmits commands to the BMS to manage the operation of battery packs of the electric vehicle, as described herein;
a positioning module 322 that receives position data, including a current location 324, from the a positioning system (e.g., the positioning system 105 in FIG. 1) on the bus of the electric vehicle and performs specified operations, as described herein;
a sensor module 326 that receives sensor signals from a sensor module (e.g., the sensor module 212 in FIG. 2) on a bus of the electric vehicle;
a controller/ECU module 328 that transmits commands to a controller/ECU (e.g., the controller/ECU 214 in FIG. 2) on the bus of the electric vehicle regulating the operation of the electric motors of the electric vehicle, the commands based at least in part on sensor signals received from the sensor module 326, battery status data received from the BMS module 320, commands received from an energy management module 340, or a subset thereof, as described herein;
a battery service module 330 that monitors and manages battery service operations (e.g., sending a request to a charge station to receive energy to charge the one or more battery packs 104, instructing the battery pack lock module 202 to release the one or more battery pack 104 locks, etc.) performed on battery packs of the electric vehicle and that optionally includes handshaking and encryption functions that are used during communication between the electric vehicle and battery service stations, a control center, and/or other devices, as described herein;
an energy-aware navigation module 332 that provides navigation services based at least in part on battery status data received from the BMS module 320, position data received from the positioning module 322, destinations 334 that are either user-selected or determined based at least in part on a profile 352 of the user of the electric vehicle, local conditions (e.g., traffic, weather, road conditions, etc.) data included in a battery service station database 364 (e.g., geographic locations of battery service stations, status of the battery service stations, etc.), and/or a subset thereof, as described herein; the energy-aware navigation module 332 determines routes 336 based on the destinations 334 and the current location 324 and displays graphical representations of destinations, routes, battery service stations, etc., on maps 338 displayed on a display device of the electric vehicle 102 (e.g., the display device 306);
the energy management module 340 that provides commands to the controller/ECU of the electric vehicle via the controller/ECU module 328 based at least in part on battery status data received from the BMS module 320, position data received from the positioning module 322, the destinations 334, data included in the battery service station database 364, the profile 352 of a user of the electric vehicle, an energy plan 342, and/or a subset thereof, as described herein;
a value-added services module 344 that provides value-added services based at least in part on battery status data received from the BMS module 320, position data received from the positioning module 322, the destination 360 selected by the user of the electric vehicle, data included in the battery service station database 364, the profile 352 of a user of the electric vehicle, and/or a subset thereof, as described herein;
an user account module 346 that manages account information for the users of the electric vehicle 102 and includes user identifiers 348 that uniquely identify users of the electric vehicle 102, account data 350 that indicates the status of user accounts (e.g., active, expired, cancelled, insufficient funds, etc.), profiles 352 (e.g., including user identifier, driving history, driving style (e.g., the user accelerates quickly from a stop, accelerates slowly from a stop, drives fast, drives slowly, etc.), historical information about destinations and/or points of interest visited by the user, routes driven by the users, one or more reference points associated with users, etc.), and/or a subset thereof;
a database module 354 that interfaces with databases of the electric vehicle control system 107;
a battery status database 356 that includes identifiers for the battery packs and present and/or historical information about the status of the battery packs of the electric vehicle 102;
a geographic location database 358 of the electric vehicle that includes destinations 360 (e.g., addresses, etc.) and/or points of interest 362 (e.g., landmarks, businesses, etc.); and
the battery service station database 364 that includes locations 366 and/or status information 368 about battery service stations.

In some embodiments, the geographic location database 358 is included in the energy-aware navigation module 332. In some embodiments, the battery service station database 364 is included in the energy-aware navigation module 332. In some embodiments, the battery service station database 364 is included in the geographic location database 358. In some embodiments, battery status database 356 is included in the energy-aware navigation module 332.

Each of the above identified elements may be stored in one or more of the previously mentioned memory devices, and corresponds to a set of instructions for performing a function described above. The set of instructions can be executed by one or more processors (e.g., the CPUs 302). The above identified modules or programs (i.e., sets of instructions) need not be implemented as separate software programs, procedures or modules, and thus various subsets of these modules may be combined or otherwise re-arranged in various embodiments. In some embodiments, each of the above identified modules or programs are implemented using discrete circuitry. In some embodiments, subsets of the above identified modules or programs are implemented using respective discrete circuitry. In some embodiments, the memory 310 may store a subset of the modules and data structures identified above. Furthermore, the memory 310 may store additional modules and data structures not described above.

Although FIG. 3 shows an “electric vehicle control system,” FIG. 3 is intended more as functional description of the various features which may be present in the electric vehicle control system than as a structural schematic of the embodiments described herein. In practice, and as recognized by those of ordinary skill in the art, items shown separately could be combined and some items could be separated. For example, the energy-aware navigation module 332 may be combined with the energy management module 340.

### Energy Management

As discussed above, the theoretical maximum range of an electric vehicle may depend on several factors. For example, simply calculating the theoretical maximum range based on the charge levels of the battery packs of the electric vehicle and the average energy consumption of an electric motor of the electric vehicle may not be sufficient. It is often the case that external conditions such as environmental conditions (e.g., weather, terrain, etc.) and traffic may substantially affect the theoretical maximum range of the electric vehicle. For example, extreme temperatures may degrade the performance of the battery packs of the electric vehicle. Similarly, traffic jams or slow traffic may prolong the overall amount of time that the electric vehicle is operating. Furthermore, the speed of the electric vehicle may affect the theoretical maximum range of the electric vehicle. For example, the energy required to overcome wind resistance increases as the speed of the electric vehicle increases, and accordingly, the amount of charge available to drive the electric motor may be decreased. Moreover, each battery pack may behave differently. For example, an older battery pack (e.g., one that has experience many charge/discharge cycles) may not provide the same range as a new battery pack.

The embodiments describe below provide an energy management system for managing energy usage in an electric vehicle that addresses at least some of the above mentioned factors. For example, the energy management module 340 and/or the energy-aware navigation module 332 may provide energy management operations described below.

In some embodiments, the energy management system may supplement the functionality of a traditional navigation system. In some embodiments, in addition to providing route guidance, the energy management system provides information about the charge levels of the battery packs of the electric vehicle and/or information about locations and availabilities of battery service stations. For example, the energy management module 340 may provide this information to the traditional navigation system.

In some embodiments, the energy management system may be a standalone component within the electric vehicle. In these embodiments, the energy management system may include a navigation system that includes energy management capabilities (e.g., the energy-aware navigation module 332, etc.).

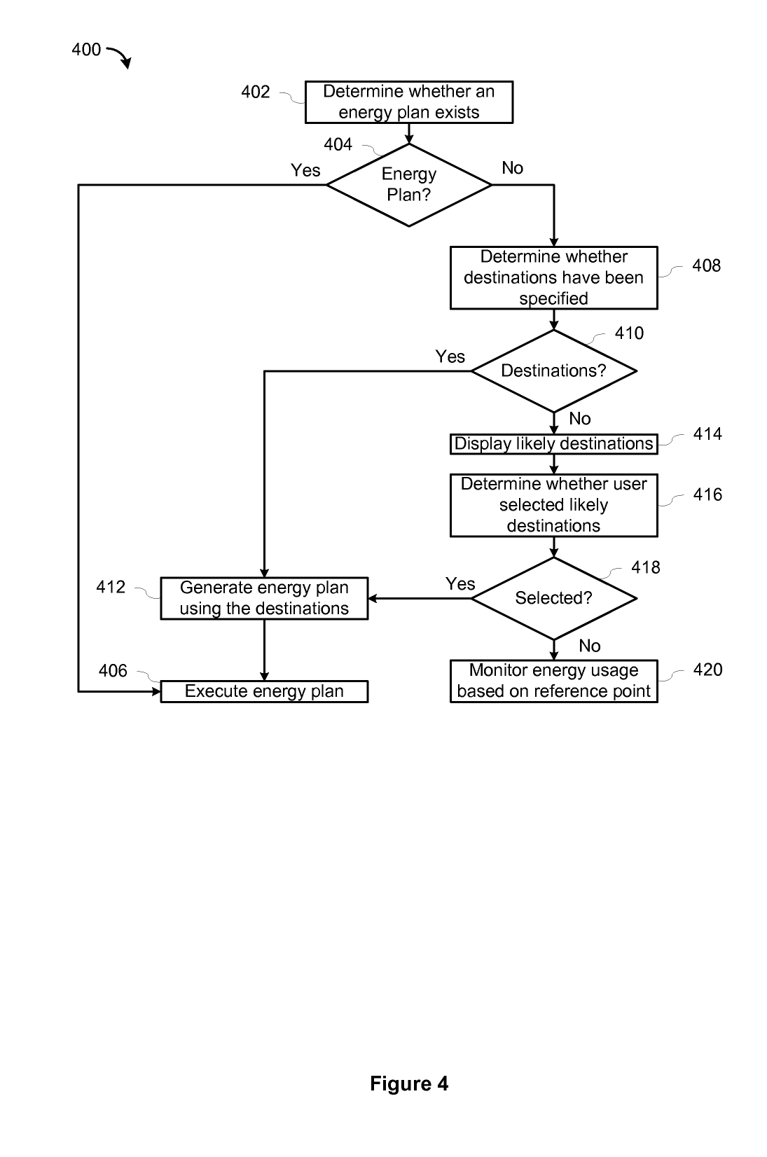

FIG. 4 is a flow diagram of a method 400 for providing energy-aware navigation services for an electric vehicle, according to some embodiments. The energy-aware navigation module 332 determines (402) whether an energy plan exists.

If an energy plan exists (404, yes), the energy-aware navigation module 332 executes (406) the energy plan. In some embodiments, energy plan includes a turn-by-turn and/or a point-by-point navigation plan (e.g., a route plan) from a current location of the electric vehicle to one or more destinations/waypoints. In some embodiments, the destinations/waypoints include battery service stations (e.g., charge stations, battery exchange stations, etc.). In some embodiments, the energy plan is generated by the energy-aware navigation module 332. The energy plan may be used by the energy-aware navigation module 332 to provide route guidance to the user. Note that step 406 is described in more detail with respect to FIG. 10.

Note that during the execution of the energy plan, the user of the electric vehicle may change. For example, on a long trip, a first user may be a driver of the electric vehicle for a portion of the trip, while a second user may be the driver of the electric vehicle for the rest of the trip. In some embodiments, if there is a change in users during the execution of the energy plan, the energy-aware navigation module 332 resets and recalculates the energy plan (e.g., based on a profile of the user driving the vehicle, etc.). In doing so, the energy-aware navigation module 332 accounts for differences in preferences and/or driving styles of the users.

In some embodiments, if there is a change in users during the execution of the energy plan, the energy-aware navigation module 332 queries the new user to determine whether the new user desires to continue using the existing energy plan. If the new user wants to use the existing energy plan, the energy-aware navigation module 332 continues to execute the existing energy plan. Otherwise, the energy-aware navigation module 332 resets and recalculates the energy plan.

In some embodiments, if there is a change in users during the execution of the energy plan, the energy-aware navigation module 332 continues executing the existing energy plan. In these embodiments, if the new user wants to create a new energy plan, the new user must instruct the energy-aware navigation module 332 to do so.

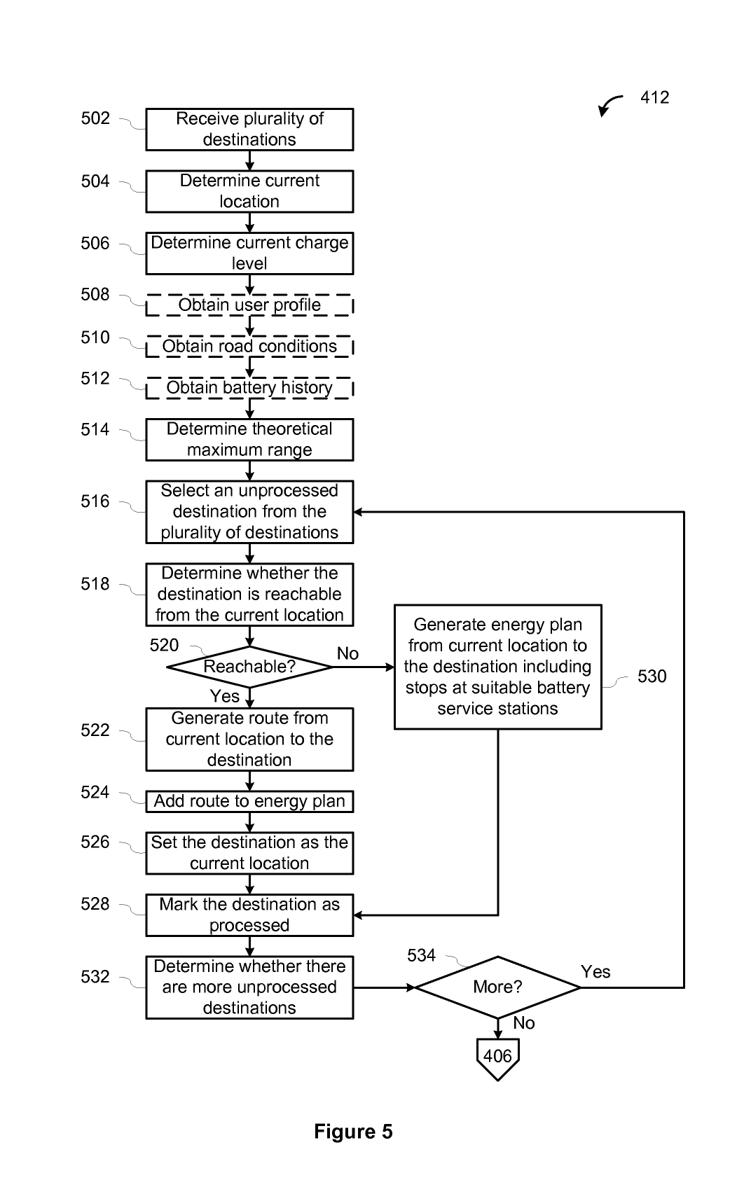

In some embodiments, if the energy plan does not exist (404, no), the energy-aware navigation module 332 determines (408) whether one or more destinations have been specified by the user of the electric vehicle. If the user has specified one or more destinations (410, yes), the energy-aware navigation module 332 generates (412) an energy plan using the destinations. Note that step 412 is described in more detail with respect to FIG. 5.

In some embodiments, if the user has not specified one or more destinations (410, no), the energy-aware navigation module 332 displays (414) likely destinations for the user. In some embodiments, the energy-aware navigation module 332 displays the likely destinations on a map displayed in a user interface of the electric vehicle. In some embodiments, the energy-aware navigation module 332 displays the likely destinations as a list in the user interface of the electric vehicle. In some embodiments, the energy-aware navigation module 332 determines the likely destinations based on the past driving history (e.g., nearby destinations for the user), nearby points of interest, and the like. In some embodiments, the energy-aware navigation module 332 displays the likely destinations on a map in ranked order. For example, the likely destinations may be displayed in rank order on a list displayed in the user interface of the electric vehicle 102. On the other hand, the likely destinations may be displayed on the map, visual indicators (e.g., colors, numbers, icons of varying sizes, etc.) may be displayed with the likely destinations to indicate the rank order of the likely destinations. In some embodiments, the rank order of the likely destinations are determined based on a distance from the current location of the electric vehicle, the number of times the user visited respective destinations, the amount of time the user spent at the respective destinations, user-specified rankings of destinations, or a combination thereof. For example, a user's home and work addresses are typically ranked high on the list of likely destinations. In these embodiments, the information is obtained from the user profile 352.

In some embodiments, in addition to determining likely destinations based on the user's profile, the energy-aware navigation module 332 uses aggregate data from a plurality of users. For example, the aggregate data may include the number of times the plurality of users visited respective destinations, the amount of time the plurality of users spent at the respective destinations, user rankings of the respective destinations, or a combination thereof.

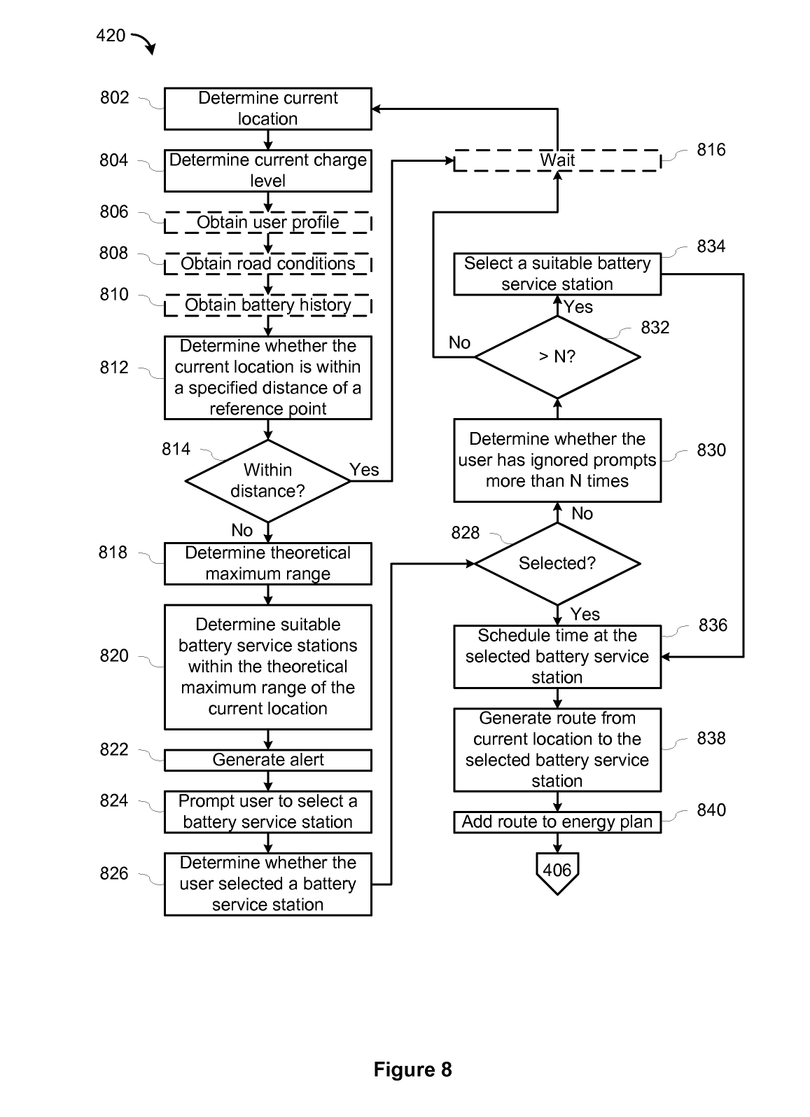

The user of the electric vehicle may (but is not required to) select one or more of the likely destinations. The energy-aware navigation module 332 then determines (416) whether the user selected one or more of the likely destinations. If the user selected one or more of the likely destinations (418, yes), the energy-aware navigation module 332 generates (412) an energy plan using the likely destinations. If the user did not select one or more of the likely destinations (418, no), the energy-aware navigation module 332 monitors (420) energy usage based on a reference point. In some embodiments, the reference point is the most likely destination from the ranked list of destinations. Note that step 420 is described in more detail with respect to FIG. 8.

FIG. 5 is a flow diagram expanding on step 412 of FIG. 4, according to some embodiments. The energy-aware navigation module 332 receives (502) one or more waypoints or destinations. In some embodiments, the energy-aware navigation module 332 receives the plurality of destinations from the user of the electric vehicle. In some embodiments, the energy-aware navigation module 332 determines the plurality of destinations based on the profile 352 of the user. For example, the energy-aware navigation module 332 may use historical information stored in the profile 352, the date, the day of the week, the time of day, or a subset thereof to determine a likely destination of the user.

In some embodiments, prior to operating the electric vehicle 102, the electric vehicle control system 107 identifies the user. For example, the electric vehicle control system 107 may identify the user by a unique identifier (e.g., a personal identification number, a user name and password, an identifier included in a key for the electric vehicle 102, an identifier included in a radio frequency identification card, an identifier included in a smart card, etc.).

The energy-aware navigation module 332 determines (504) a current location of the electric vehicle. In some embodiments, the energy-aware navigation module 332 determines the current location based on position data received from the positioning module 322. The energy-aware navigation module 332 determines (506) current charge levels for the battery packs of the electric vehicle. In some embodiments, the energy-aware navigation module 332 determines the current charge levels for the battery packs of the electric vehicle based on battery status data received form the BMS module 320.

In some embodiments, the energy-aware navigation module 332 obtains (508) the profile 352 of the user of the electric vehicle. In some embodiments, the energy-aware navigation module 332 obtains the profile 352 of the user from the control center 130. In some embodiments, the energy-aware navigation module 332 obtains the profile 352 from the user account module 346 of the electric vehicle control system 107. In these embodiments, the profile 352 of the user was previously obtained from the control center.

In some embodiments, the energy-aware navigation module 332 obtains (510) road conditions. In some embodiments, the energy-aware navigation module 332 obtains the road conditions from the control center. In some embodiments, the energy-aware navigation module 332 obtains the road conditions from a third party provider. In some embodiments, the road conditions include speed limits of roads, the current and future weather forecasts, terrain information (e.g., grade, road type, etc.), and current and historical traffic conditions on the road.

In some embodiments, the energy-aware navigation module 332 obtains (512) a battery history for the one or more battery packs of the electric vehicle. In some embodiments, the energy-aware navigation module 332 obtains the battery history from the battery status database 356. In some embodiments, the energy-aware navigation module 332 obtains the battery history from the control center.

Note that steps 504-512 may be performed in any order.

The energy-aware navigation module 332 then determines (514) the theoretical maximum range of the electric vehicle. In some embodiments, the energy-aware navigation module 332 determines the theoretical maximum range of the electric vehicle based at least in part on the battery status data (e.g., charge levels, etc.) received from the BMS module 320, the battery history (e.g., the number of charge/discharge cycles of the battery packs, the age of the battery packs, etc.), position data received from the positioning module 322, the profile 352, properties of the electric motors (e.g., power consumption, etc.), the road conditions (e.g., types of terrain on which the roads are situated, weather, traffic, speed limits, etc.), a specified speed of the electric vehicle (e.g., speeds no greater than the speed limit of respective roads, an average speed, etc.), the time of day, the day of the week, or a subset thereof. In some embodiments, the theoretical maximum range of the electric vehicle includes a margin of safety (e.g., a 10% margin). This margin of safety is used to account for unpredictable situations that may arise during the operation of the electric vehicle (e.g., traffic jams, failure of battery packs, etc.). In some embodiments, the margin of safety is determined dynamically based on the charge levels of the battery packs and the distance to the closest battery service station.

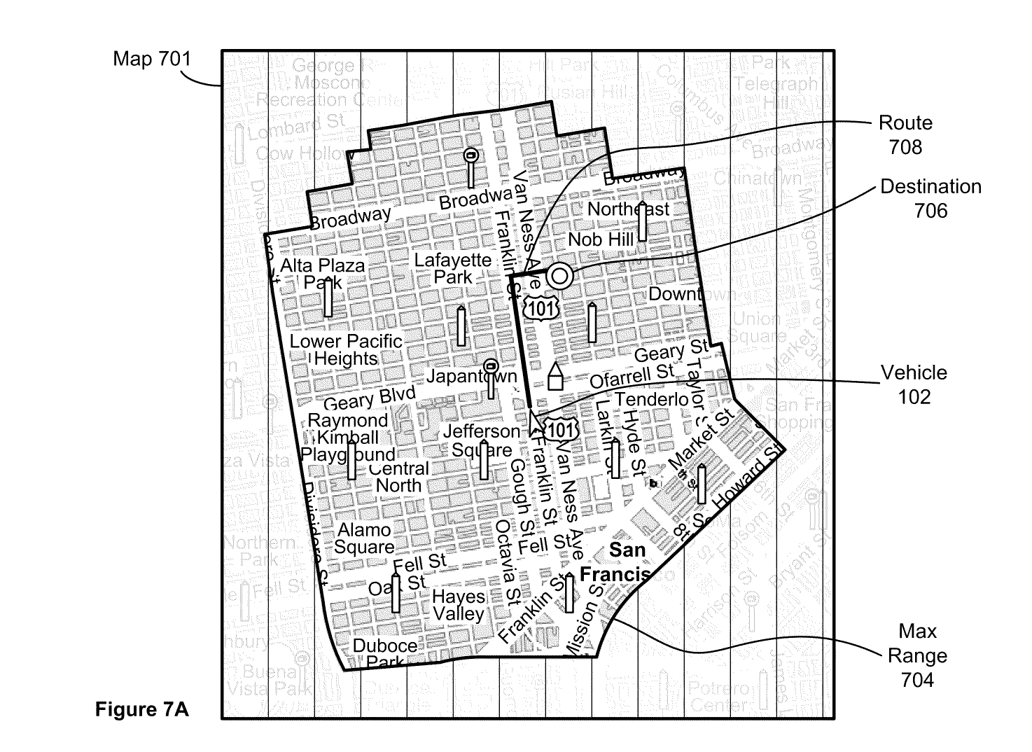

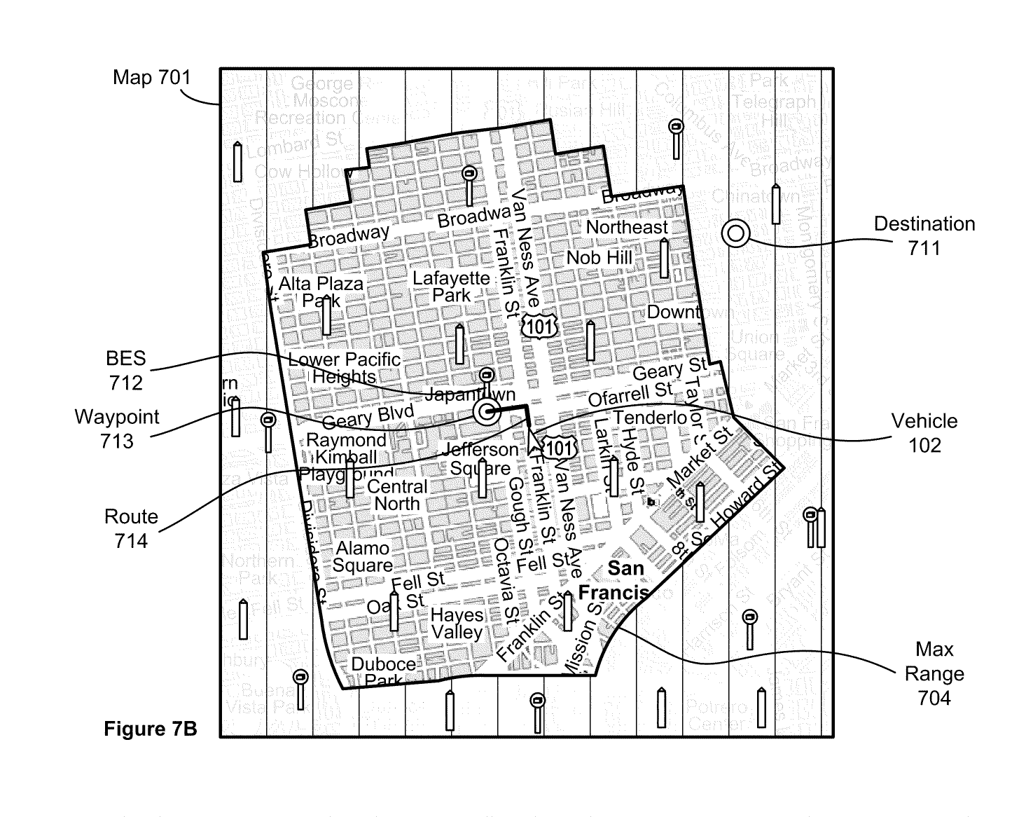

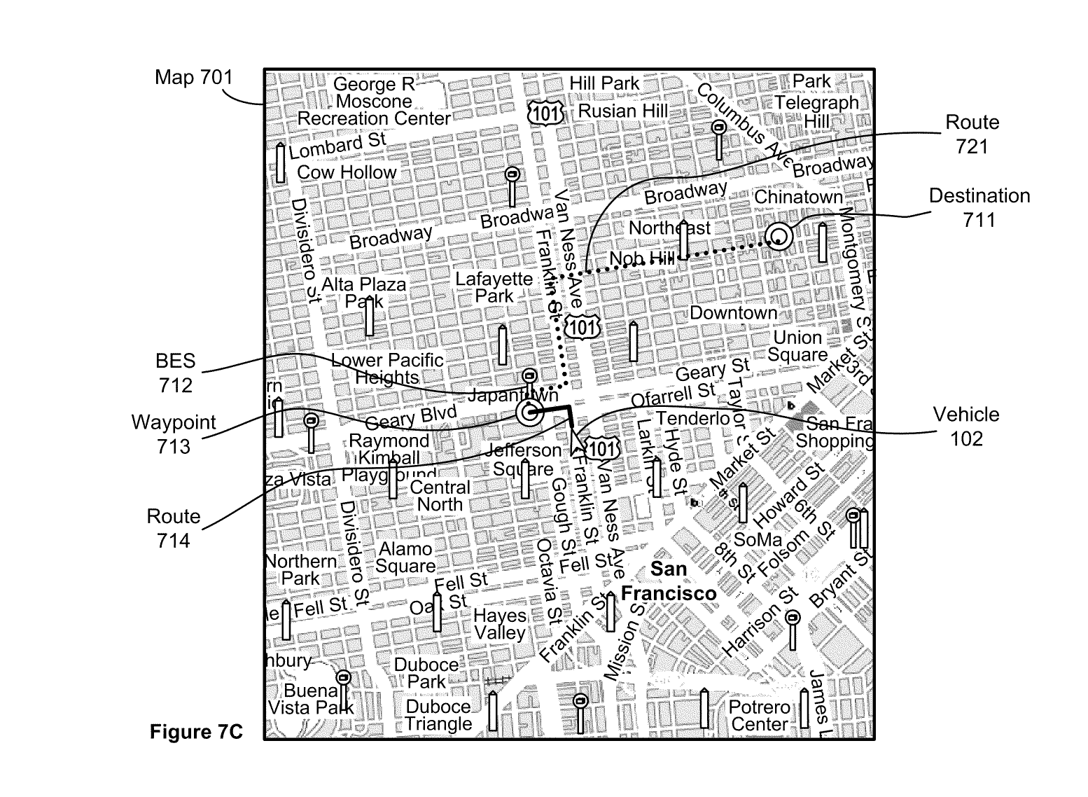

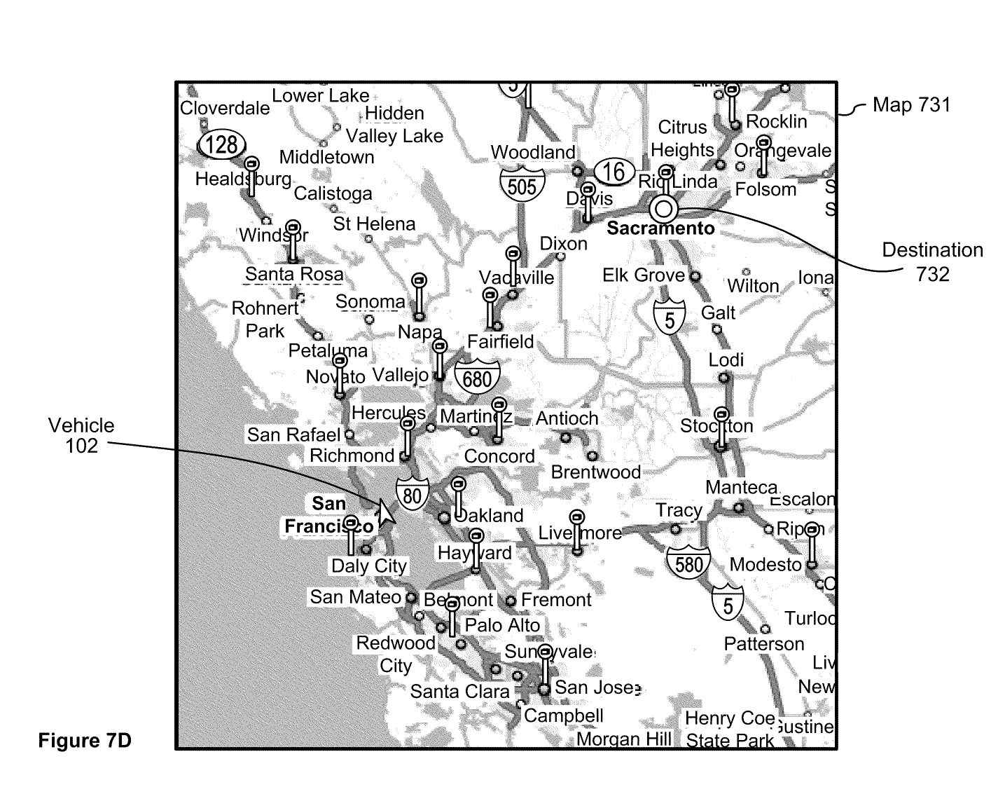

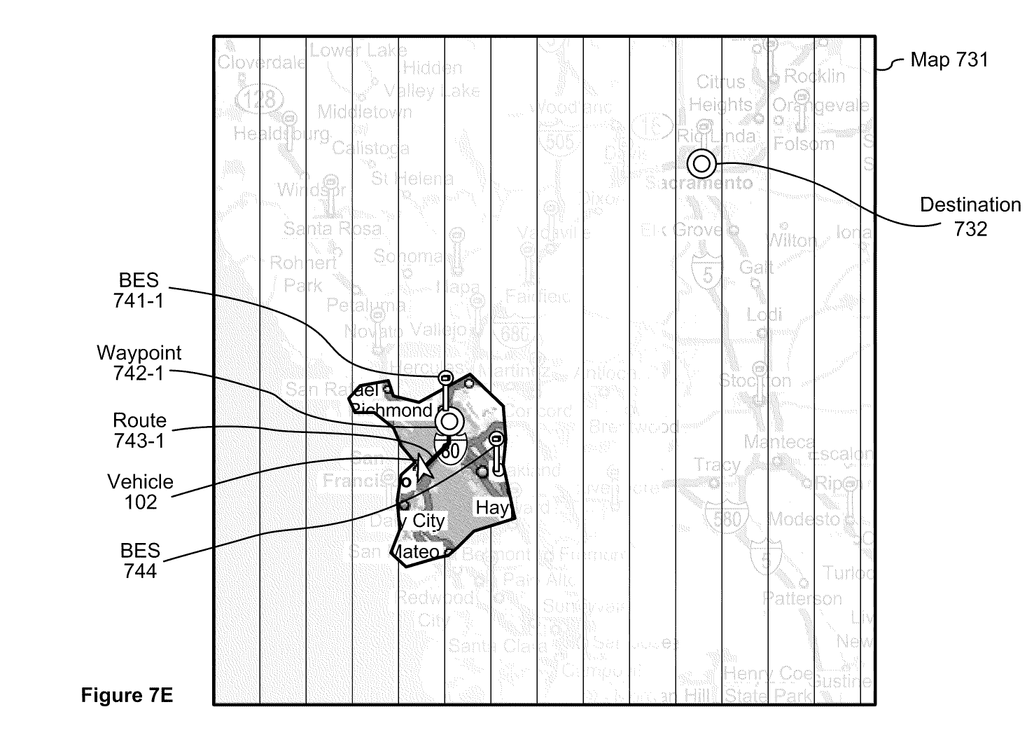

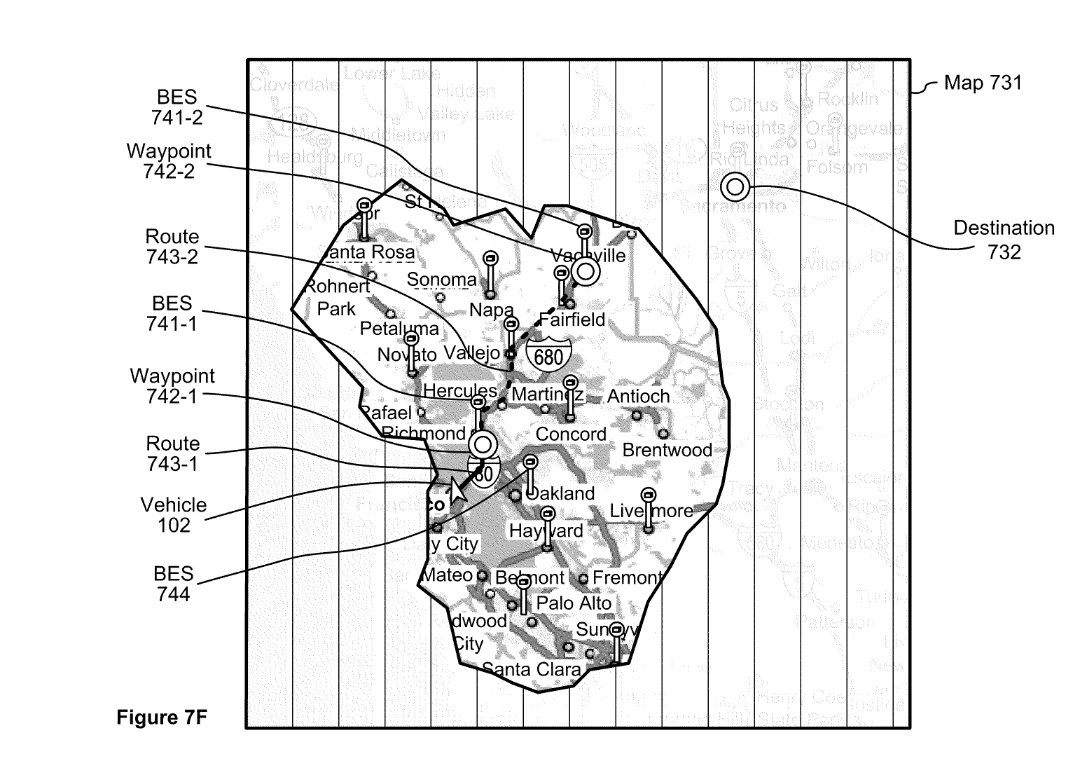

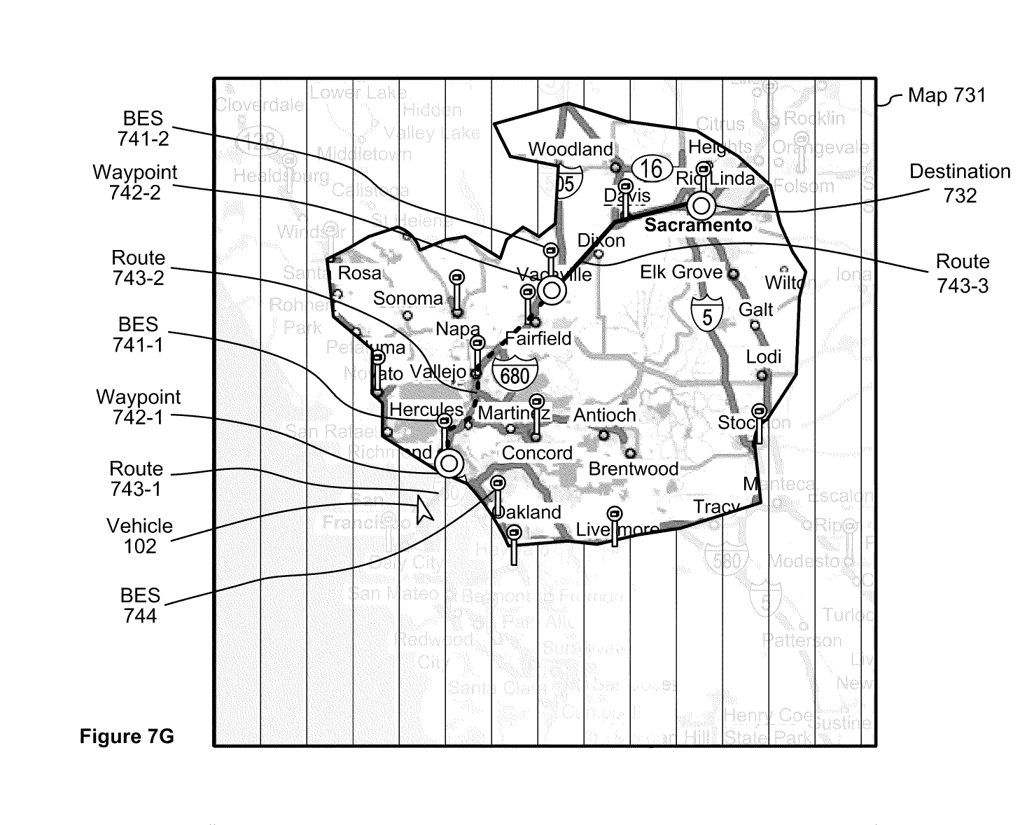

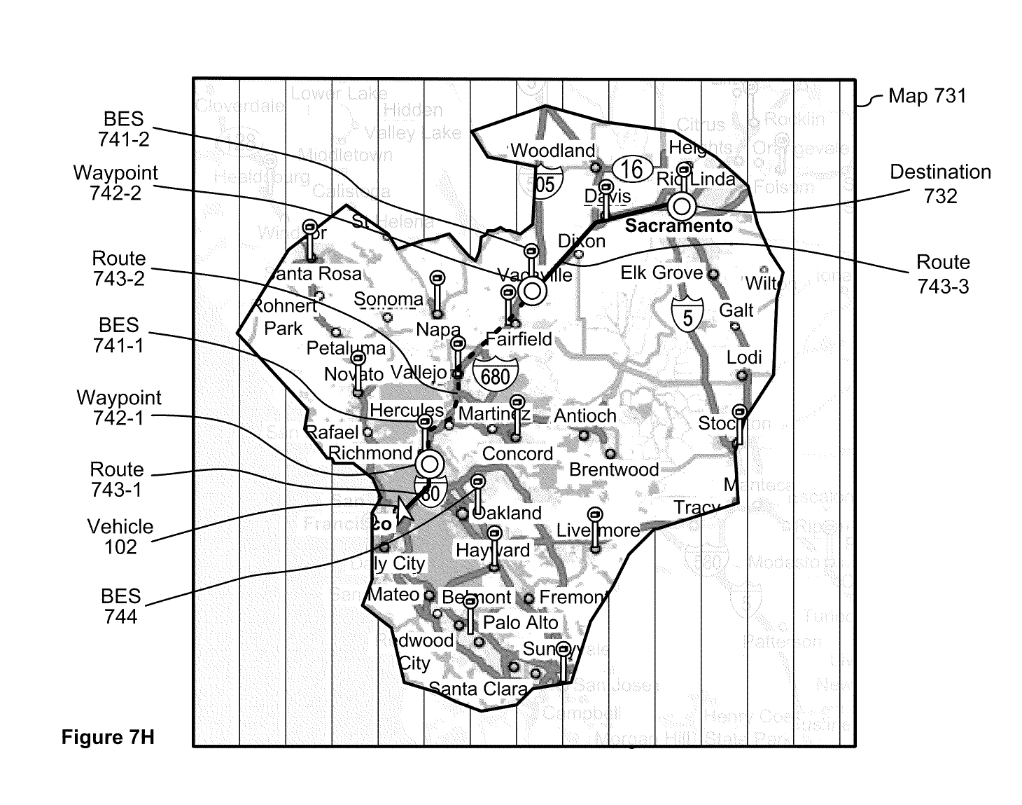

In some embodiments, the energy-aware navigation module 332 displays, in the user interface of the electric vehicle, the theoretical maximum range of the electric vehicle on a map including the current location of the electric vehicle. FIG. 7A illustrates an exemplary user interface of the electric vehicle 102 displaying a map 701 including a current location of the electric vehicle 102 and a destination 706. A visual indicator (e.g., shading, colors, etc.) is used to indicate that destinations outside of a theoretical maximum range 704 are not reachable. Destinations within the theoretical maximum range 704 are reachable on the current charge levels of the battery packs.

Returning to FIG. 5, the energy-aware navigation module 332 then selects (516) an unprocessed destination from the plurality of destinations and determines (518) whether the destination is reachable from the current location based on the theoretical maximum range. Note that the energy-aware navigation module 332 uses road data (e.g., from the geographic location database 358) to determine whether the destination is reachable from the current location (i.e., whether the charge levels of the battery packs are sufficient to get the electric vehicle 102 to the destination). Thus, the determination is made based on an actual route and not based on whether the destination is within a single fixed radius of the theoretical maximum range of the current location (e.g., a circle). In some embodiments, the energy-aware navigation module 332 determines whether the destination is reachable from the current location by: calculating a route from the current location to the destination, calculate the driving distance of the route, and comparing the driving distance to the theoretical maximum range to determine whether the destination is reachable from the current location.

In some cases, the destination is reachable (e.g., in FIG. 7A, the destination 706 is within the theoretical maximum range 704). If the destination is reachable (520, yes), the energy-aware navigation module 332 generates (522) a route (e.g., route 708 in FIG. 7A) from the current location to the destination. The energy-aware navigation module 332 then adds (524) the route to the energy plan and sets (526) the destination as the current location. In some embodiments, after setting the destination as the current location, the energy-aware navigation module 332 predicts the amount of energy required for the electric vehicle to reach the destination and calculates predicted charge levels of the battery packs of the electric vehicle at the destination (e.g., after the electric vehicle has reached the destination). By setting the destination as the current location, the energy-aware navigation module 332 can compute whether the electric vehicle can reach the next destination (if any).

The energy-aware navigation module 332 then marks (528) the destination as processed.

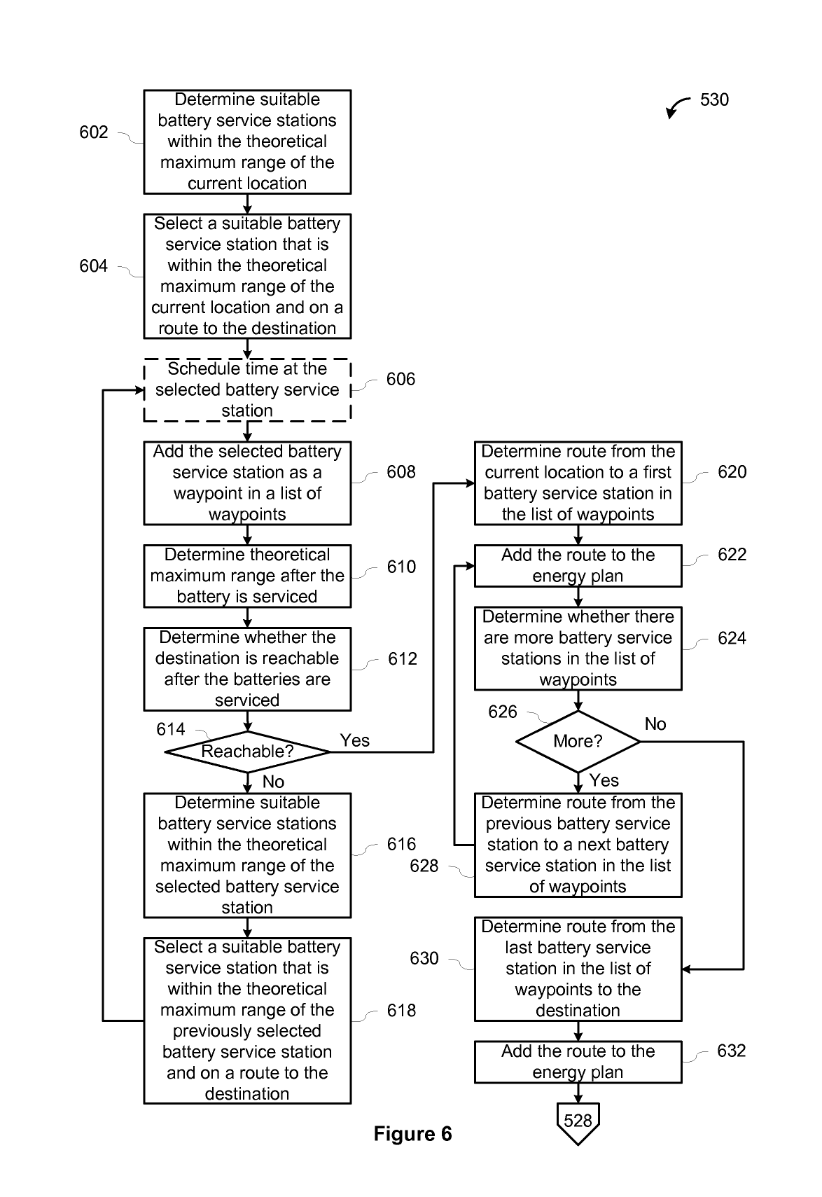

In some cases, the destination is not reachable unless the battery pack is first serviced (e.g., in FIG. 7B, destination 711 is outside of the theoretical maximum range 704). If the destination is not reachable (520, no), the energy-aware navigation module 332 generates (530) an energy plan from the current location to the destination that includes stops at suitable battery service stations. This step is described in more detail below with respect to FIG. 6 and FIGS. 7B-7H. After generating the energy plan, the energy-aware navigation module 332 marks (528) the destination as processed.

After marking the destination as processed, the energy-aware navigation module 332 determines (532) whether there are more unprocessed destinations. If there are more unprocessed destinations (534, yes), the energy-aware navigation module 332 returns to step 516. If there are no more unprocessed destinations (534, no), the energy-aware navigation module 332 proceeds to step 406 in FIG. 4.

In some embodiments, if the user of the electric vehicle cancels the energy plan, the energy-aware navigation module 332 performs the operations in FIG. 8.

FIG. 6 is a flow diagram expanding on step 530 of FIG. 5, according to some embodiments. The energy-aware navigation module 332 determines (602) suitable battery service stations within the theoretical maximum range of the current location. A suitable battery service station is a battery service station that is within the theoretical maximum range of the current location and that is able to service the battery packs of the electric vehicle (e.g., has available battery exchange bays for exchanging battery packs, has available charge stations for charging battery packs, has the type of battery packs that are compatible with the electric vehicle, the compatible battery packs are charged, etc.). In some embodiments, the energy-aware navigation module 332 queries the battery service station database 364 to determine a set of battery service stations within the theoretical maximum range of the current location. In some embodiments, the energy-aware navigation module 332 receives updated information about the status of battery service stations from the control center (e.g., the control center 130 in FIG. 1). The energy-aware navigation module 332 may store this information in the battery service station database 364. In these embodiments, the energy-aware navigation module 332 only includes battery service stations that have space and time available to service the battery packs of the electric vehicle. Note that the energy-aware navigation module 332 uses road data (e.g., from the geographic location database 358) to determine the set of battery service stations within the theoretical maximum range of the current location. For example, the energy-aware navigation module 332 may first determine a set of routes to destinations that may be reached via roads from the current location of the electric vehicle. The energy-aware navigation module 332 may then determine a set of battery service stations based on these determined routes and based on data stored in the battery service station database 364. Thus, the set of battery service stations is not the set of battery service stations that are within radius of the theoretical maximum range of the current location (e.g., a circle). In some embodiments, the energy-aware navigation module 332 first determines a route from the current location to the destination. The energy-aware navigation module 332 then determines a set of battery service stations within a specified distance of the determined route (e.g., within five miles of the determined route). In some embodiments, a route is determined based on aggregated road segments. In some embodiments, an aggregated road segment includes a plurality of road segments for which road conditions (e.g., traffic, speed limit, terrain type, elevation, etc.) of the individual segments in the plurality of segments are averaged. In doing so, approximate routes may be quickly calculated and updated in real-time.

In some embodiments, the energy-aware navigation module 332 displays the suitable battery service stations in the user interface of the electric vehicle. For example, referring to FIG. 7B, the suitable battery service stations include the battery service stations within the theoretical maximum range 704 (e.g., the un-shaded areas of the map 701). In some embodiments, the energy-aware navigation module 332 uses a visual indicator to indicate the suitable battery service stations that are along a route to the destination. For example, the battery service stations that are along a route to the destination may be highlighted.

The energy-aware navigation module 332 then selects (604) a suitable battery service station (that is within the theoretical maximum range of the current location and on a route to the destination. In some embodiments, the energy-aware navigation module 332 selects the battery service station based on the profile 352 (e.g., including user preferences, driving history of the user, previous battery service stations used by the user, etc.) and/or a battery service station specified by the user. In some embodiments, the energy-aware navigation module 332 allows the user to select a suitable battery service station.

In some embodiments, the energy-aware navigation module 332 verifies that the selected battery service station can service the battery of the electric vehicle. For example, if the battery service station is a battery exchange station, the energy-aware navigation module 332 verifies that the battery exchange station has battery packs that are compatible with the electric vehicle and has an available battery exchange bay for exchanging the battery packs of the electric vehicle. Similarly, if the battery service station is a charge station, the energy-aware navigation module 332 verifies that the charge station is available to charge the battery packs of the electric vehicle.

In some embodiments, the energy-aware navigation module 332 then schedules (606) time for the electric vehicle to be serviced at the selected battery service station. In some embodiments, the energy-aware navigation module 332 schedules time at the selected battery service station based on an estimated time of arrival of the electric vehicle at the selected battery service station. In some embodiments, the energy-aware navigation module 332 also reserves a battery and a battery exchange platform for the electric vehicle. In some embodiments, the energy-aware navigation module 332 uses the one or more communication interfaces 304 to communicate with the selected battery service station to reserve time at the selected battery service station. In some embodiments, the energy-aware navigation module 332 uses the one or more communication interfaces 304 to communicate with the control center to reserve time at the selected battery service station. In these embodiments, the control center then transmits the reservation to the selected battery service station.

The energy-aware navigation module 332 adds (608) the selected battery service station as a waypoint in a list of waypoints. The list of waypoints may then be used by the energy-aware navigation module 332 to provide guidance (e.g., turn-by-turn directions, etc.) for the route. Note that a waypoint may also include a home of the user, a workplace of the user, a location where the electric vehicle is charged, a user-specified destination, a destination determined based on a user profile, and a destination determined based on aggregate user profile data.

The energy-aware navigation module 332 then determines (610) the theoretical maximum range of the electric vehicle after the battery packs are serviced. As described above, the energy-aware navigation module 332 may determine the theoretical maximum range of the electric vehicle based at least in part on the battery status after exchanging or recharging the battery packs, the battery history, position data received from the positioning module 322, the profile 352, properties of the electric motors, the road conditions, a specified speed of the electric vehicle, the time of day, the day of the week, or a subset thereof. Again, the theoretical maximum range of the electric vehicle may include a margin of safety (e.g., a 20% margin). This margin of safety is used to account for unpredictable situations that may arise during the operation of the electric vehicle (e.g., traffic jams, failure of battery packs, etc.). The battery service may include a battery charging service at a charging station and/or a battery exchange service at a battery exchange station.

The energy-aware navigation module 332 determines (612) whether the destination is reachable after the battery packs are serviced. The energy-aware navigation module 332 may make this determination by first determining a route from the selected battery service station to the destination, and then determining whether the length of the route is within the theoretical maximum range.

If the destination is not reachable after the battery packs are serviced (614, no), the energy-aware navigation module 332 determines (616) suitable battery service stations within the theoretical maximum range of the selected battery service station (e.g., as described above).

The energy-aware navigation module 332 then selects (618) a new suitable battery service station that is within the theoretical maximum range of the previously selected battery service station and on a route to the destination. As discussed above, the energy-aware navigation module 332 may select the new suitable battery service station based on the profile 352 (e.g., including user preferences, driving history of the user, previous battery service stations used by the user, etc.) and/or a battery service station specified by the user. In some embodiments, the energy-aware navigation module 332 allows the user to select a suitable battery service station.

The energy-aware navigation module 332 then returns to step 606.

If the destination is reachable after the battery packs are serviced (614, yes), the energy-aware navigation module 332 determines (620) a route from the current location to a first battery service station in the list of waypoints.

The energy-aware navigation module 332 then adds (622) the route to the energy plan. The energy-aware navigation module 332 determines (624) whether there are more battery service stations in the list of waypoints. If there are more battery service stations in the list of waypoints (626, yes), the energy-aware navigation module 332 determines (628) a route from the previous battery service station to a next battery service station in the list of waypoints. The energy-aware navigation module 332 then returns to step 622. If there are no more battery service stations in the list of waypoints (626, no), the energy-aware navigation module 332 determines (630) a route from the last battery service station to the destination and adds (632) the route to the energy plan. The energy-aware navigation module 332 then proceeds to step 528 in FIG. 5.

Several examples of the process described in FIG. 6 are described with reference to FIGS. 7B-7H. FIGS. 7B-7C illustrate a case where the user of the electric vehicle 102 has specified a destination 711 that is outside of the theoretical maximum range 704 of the electric vehicle. In this case, the energy-aware navigation module 332 selects and schedules time at a battery exchange station 712 at which the battery packs of the electric vehicle 102 can be exchanged for charged battery packs. The energy-aware navigation module 332 adds the battery exchange station 712 as a waypoint 713 in the list of waypoints. The energy-aware navigation module 332 then determines the theoretical maximum range of the electric vehicle 102 after the battery packs are exchanged and determines whether the electric vehicle 102 can reach the destination 711. As illustrated in FIG. 7C, the destination 711 is now within theoretical maximum range (i.e., the theoretical maximum range includes all destinations displayed in the map 701). Thus, the energy-aware navigation module 332 determines that the destination 711 is reachable from the battery exchange station 712. The energy-aware navigation module 332 then iterates through the list of waypoints to generate routes 714 and 721.

In FIG. 7D-7H, the user of the electric vehicle 102 has specified a destination 732 (e.g., Sacramento, Calif.) that requires multiple stops at battery exchange stations to reach the destination 732. A map 731 illustrated in FIGS. 7D-7H include both the current location of the electric vehicle 702 and the destination 732. As illustrated in FIG. 7E, the theoretical maximum range of the electric vehicle 102 is bounded by the shaded areas of the map 731. The energy-aware navigation module 332 determines that battery exchange stations 741-1 and 744 are reachable from the current location of the electric vehicle 102. The energy-aware navigation module 332 selects and schedules time at battery exchange station 741-1 (e.g., based on the user profile or via user input, etc.). The energy-aware navigation module 332 then adds the battery exchange station 741-1 as a waypoint 742-1 in a list of waypoints.

As illustrated in FIG. 7F, the energy-aware navigation module 332 then determines the theoretical maximum range of the electric vehicle 102 after the battery packs are exchanged and determines whether the electric vehicle 102 can reach the destination 732 from the battery exchange station 741-1. The destination 732 is still unreachable so the energy-aware navigation module 332 selects and schedules time at a battery exchange station 741-2, which is within the theoretical maximum range of the battery exchange station 741-1. The energy-aware navigation module 332 then adds the battery exchange station 741-2 as a waypoint 742-2 in the list of waypoints.

As illustrated in FIG. 7G, the energy-aware navigation module 332 then determines the theoretical maximum range of the electric vehicle 102 after the battery packs are exchange and determines whether the electric vehicle 102 can reach the destination 732 from the battery exchange station 741-2. The destination 732 is now reachable, so the energy-aware navigation module 332 determines a route 743-1 from the current location of the electric vehicle 102 to the battery exchange station 741-1, a route 743-2 from the battery exchange station 741-1 to the battery exchange station 741-2, and a route 743-3 from the battery exchange station 741-2 to the destination 732. The energy-aware navigation module 332 then adds the routes to the energy plan.

FIG. 7H illustrates the routes from the current location of the electric vehicle to the destination 732. FIG. 7H also illustrates destinations off of the routes that are also reachable. If the user decides to drive to reachable destinations off of the planned route, the energy-aware navigation module 332 monitors and determines whether the energy plan is still executable. If the energy plan is no longer executable, the energy-aware navigation module 332 repeats the process described in FIG. 6.

Note that in FIGS. 7A-7H, the energy-aware navigation module 332 selected battery exchange stations. However, the energy-aware navigation module 332 may select charge stations, battery exchange stations, and a combination thereof to generate the energy plan. In some embodiments, the energy-aware navigation module 332 asks the user to select battery service stations.

In some embodiments, the energy-aware navigation module 332 periodically updates the map (e.g., the map 701, the map 731, etc.) displayed in the user interface of the electric vehicle based on the current location of the electric vehicle, the charge levels of the battery packs of the electric vehicle, the set of suitable battery service stations (e.g., based on the charge levels of the battery packs and updated status of the battery service stations, etc.).

FIG. 8 is a flow diagram expanding on step 420 of FIG. 4, according to some embodiments. The energy-aware navigation module 332 determines (802) a current location of the electric vehicle. In some embodiments, the energy-aware navigation module 332 determines the current location based on position data received from the positioning module 322. The energy-aware navigation module 332 determines (804) current charge levels for the battery packs of the electric vehicle. In some embodiments, the energy-aware navigation module 332 determines charge levels for the battery packs of the electric vehicle based on battery status data received form the BMS module 320.

In some embodiments, the energy-aware navigation module 332 obtains (806) the profile 352 of the user of the electric vehicle, as described above (e.g., step 508 in FIG. 5).

In some embodiments, the energy-aware navigation module 332 obtains (808) road conditions, as described above (e.g., step 510 in FIG. 5).

In some embodiments, the energy-aware navigation module 332 obtains (810) battery history for the one or more battery packs of the electric vehicle, as described above (e.g., step 512 in FIG. 5).

Note that steps 802-810 may be performed in any order.

The energy-aware navigation module 332 then determines (812) whether the current location is within a specified distance of a reference point (e.g., within an area bounded by a point-of-no-return, as described below). In some embodiments, the reference point is a point at which the electric vehicle spends the most time charging (e.g., a home or an office of the user, etc.). In some embodiments, the specified distance is a specified percentage (e.g., 50%) of the theoretical maximum range of the electric vehicle based on the determined charge levels of the one or more battery packs.

If the electric vehicle is within the specified distance of the reference point (814, yes), the energy-aware navigation module 332 waits (816) for a specified time period and then returns to step 802.

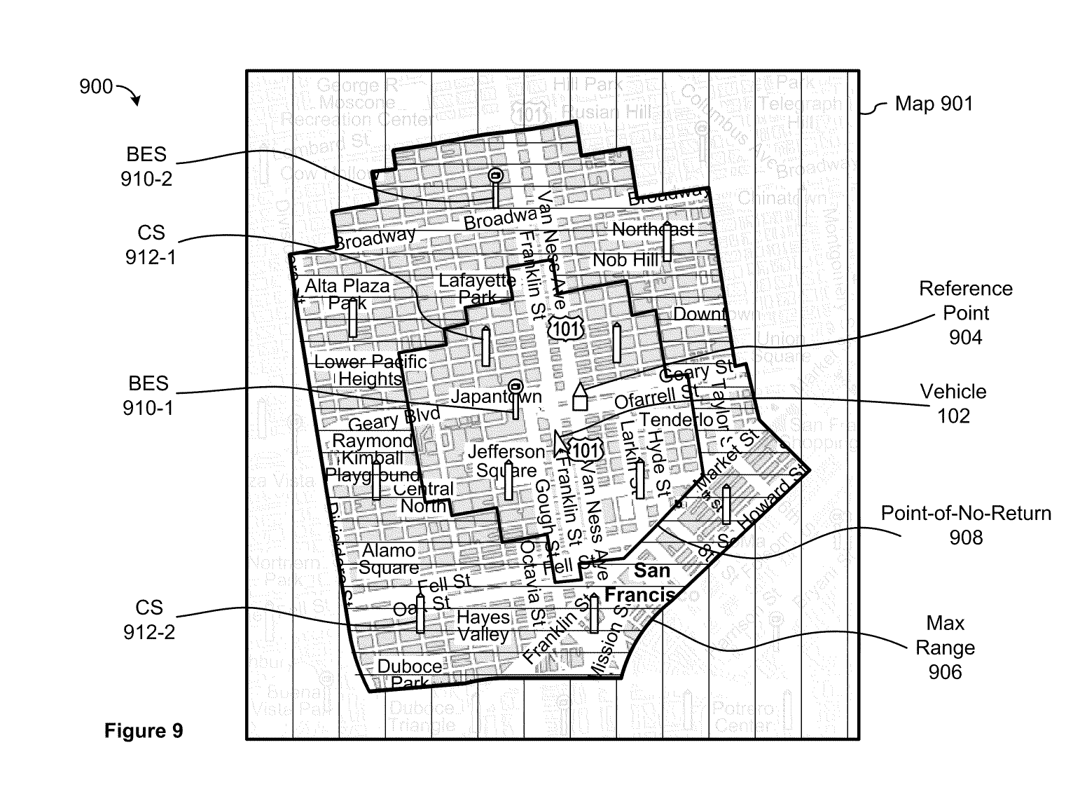

Attention is now directed to FIG. 9, which is an exemplary user interface 900 of the electric vehicle 102 displaying a map 901 and reachable destinations for the electric vehicle 102, according to some embodiments. The current location of the electric vehicle 102 and the reference point 904 is displayed on the map 901. In this case, the reference point 904 is within theoretical maximum range 906. The energy-aware navigation module 332 also calculates a point-of-no-return 908 that indicates the farthest destination that the electric vehicle can travel to and still be able to return to the reference point 904. If the electric vehicle 102 travels past the point-of-no-return 908, the battery packs of the electric vehicle must be serviced (e.g., exchanged or recharged).

Returning to FIG. 8, if the electric vehicle is not within the specified distance of the reference point (814, no), the energy-aware navigation module 332 determines (818) the theoretical maximum range of the electric vehicle (e.g., as described above with respect to step 514 of FIG. 5).

The energy-aware navigation module 332 determines (820) a set of suitable battery service stations (e.g., battery exchange stations 910 and charge stations 912 in FIG. 9) within the theoretical maximum range of the current location of the electric vehicle (e.g., as described above).

The energy-aware navigation module 332 then generates (822) an alert. The alert may be an audio alert (e.g., a sound, a voice, etc.) or a visual alert (e.g., text, etc.). The alert may be serviced by the user interface 305 (e.g., display, speakers, etc.).

The energy-aware navigation module 332 prompts (824) the user via the user interface 305 to select a battery service station. The prompt may be an audio prompt or a visual prompt via a user interface (e.g., the user interface 210 in FIG. 2, the user interface 305 in FIG. 3, etc.). The energy-aware navigation module 332 then determines (826) whether the user selected a battery service station.

If the user selected a battery service station (828, yes), the energy-aware navigation module 332 schedules (836) time at the selected battery service station (e.g., as described above with respect to step 606 of FIG. 6), generates (838) a route from the current location of the electric vehicle to the selected battery service station, and adds (840) the route to the energy plan. The energy-aware navigation module 332 then proceeds to step 406 of FIG. 4.

If the user did not select a battery service station (828, no), the energy-aware navigation module 332 determines (830) whether the user has ignored prompts to select a battery service station more than a specified number of times (e.g., after 3 times).

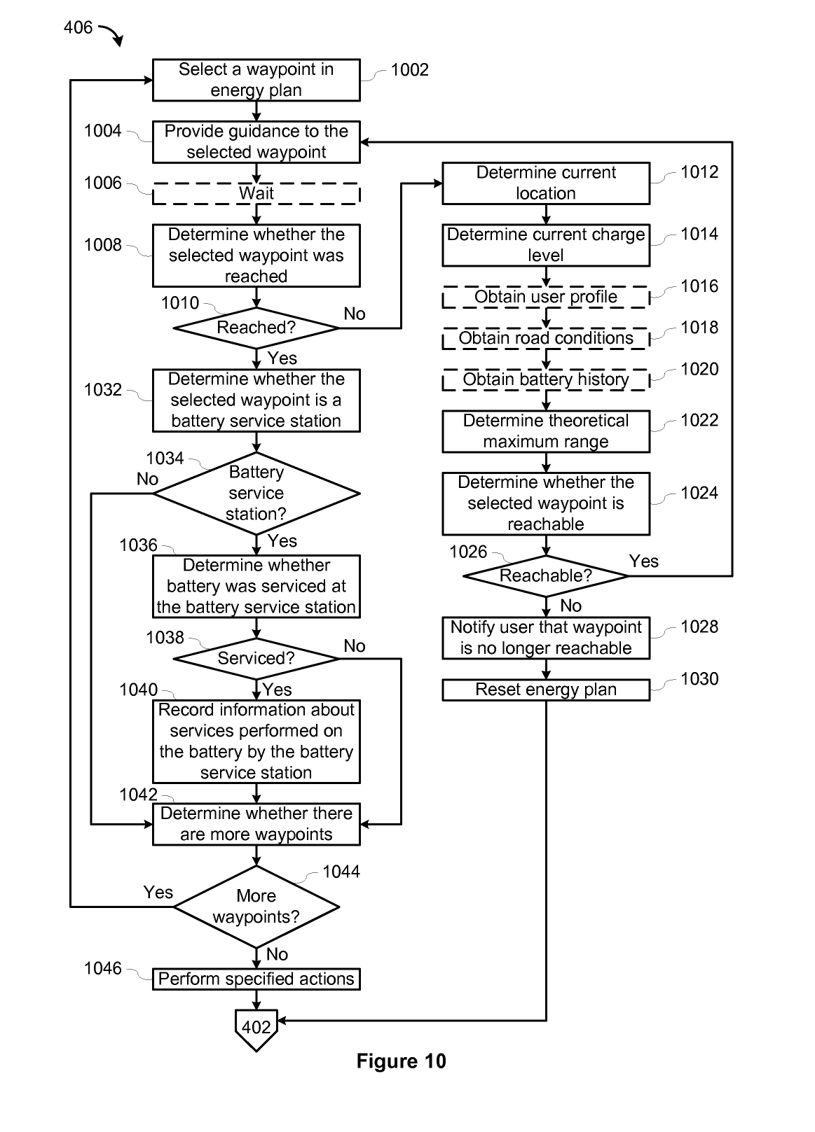

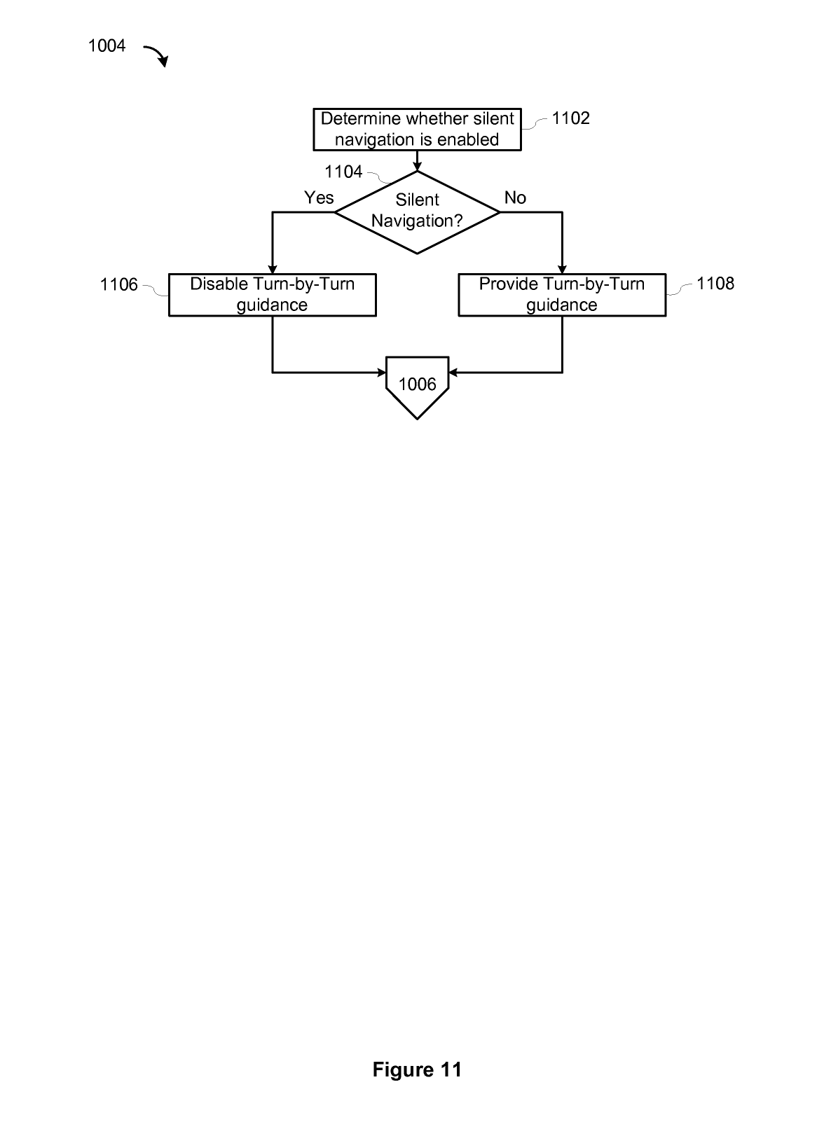

If the user has ignored prompts to select a battery service station more than the specified number of times (832, yes), the energy-aware navigation module 332 selects (834) a suitable battery service station and proceeds to step 836. The selection of the battery service station may be based on the profile 352 and/or aggregate user profile data obtained from group of users. Thus, after the user has ignored the prompts for the specified number of times, the energy-aware navigation module 332 selects a battery service station for the user and provides navigation services to the selected battery service station. In some embodiments, the energy-aware navigation module 332 provides guidance using the energy plan regardless of whether the user has specified a silent navigation mode (as described with respect to FIG. 11 below).

If the user has ignored prompts to select a battery service station less than the specified number of time (832, no), the energy-aware navigation module 332 proceeds to step 816.

FIG. 10 is a flow diagram expanding on step 406 in FIG. 4, according to some embodiments. The energy-aware navigation module 332 selects (1002) a waypoint in the energy plan. When the energy-aware navigation module 332 starts executing the energy plan, the energy-aware navigation module 332 selects the first waypoint on the energy plan. During subsequent iterations, the energy-aware navigation module 332 selects the next waypoint on the energy plan.

The energy-aware navigation module 332 provides (1004) guidance to the selected waypoint using the route in the energy plan. In some embodiments, if the electric vehicle goes off of the route, the energy-aware navigation module 332 generates a new route based on the current location of the electric vehicle and the selected waypoint, and provides guidance based on the new route. In some embodiments, the energy-aware navigation module 332 provides audio guidance (e.g., voice, etc.). In some embodiments, the energy-aware navigation module 332 provides visual guidance (e.g., map, text, etc.). In some embodiments, the energy-aware navigation module 332 provides both audio and visual guidance. The energy-aware navigation module 332 then optionally waits (1006) for a specified time period.

The energy-aware navigation module 332 then determines (1008) whether the selected waypoint was reached. If the selected waypoint was not reached (1010, no), the energy-aware navigation module 332 determines (1012) the current location of the electric vehicle, as described above. The energy-aware navigation module 332 determines (1014) charge levels for the battery packs of the electric vehicle, as described above.

In some embodiments, the energy-aware navigation module 332 obtains (1016) the profile 352 of the user of the electric vehicle, as described above (e.g., step 508 in FIG. 5).

In some embodiments, the energy-aware navigation module 332 obtains (1018) road conditions, as described above (e.g., step 510 in FIG. 5).

In some embodiments, the energy-aware navigation module 332 obtains (1020) battery history for the one or more battery packs of the electric vehicle, as described above (e.g., step 512 in FIG. 5).

Note that steps 1012-1020 may be performed in any order.

The energy-aware navigation module 332 then determines (1022) the theoretical maximum range of the electric vehicle, as described above (e.g., step 514 in FIG. 5).

The energy-aware navigation module 332 then determines (1024) whether the selected waypoint is reachable. Note that a selected waypoint may no longer be reachable because of changed conditions (e.g., traffic, weather, terrain, battery pack failures, vehicle speed, etc.).

If the selected waypoint is reachable (1026, yes), the energy-aware navigation module 332 returns to step 1004. If the selected waypoint is not reachable (1026, no), the energy-aware navigation module 332 notifies (1028) the user that the waypoint is no longer reachable, resets (1030) the energy plan, and returns to step 402 in FIG. 4 to create a new energy plan.

Note that the energy-aware navigation module 332 may first determine whether the waypoint is reachable before determining whether the waypoint was reached.

If the selected waypoint was reached (1010, yes), the energy-aware navigation module 332 determines (1032) whether the selected waypoint is a battery service station. If the selected waypoint is a battery service station (1034, yes), the energy-aware navigation module 332 determines (1036) whether the battery packs of the electric vehicle were serviced at the battery service station. If the battery packs of the electric vehicle were serviced at the battery service station (1038, yes), the energy-aware navigation module 332 records (1040) information about service performed on the battery packs by the battery service station. For example, the energy-aware navigation module 332 may store the information about the service performed on the battery packs in the battery status database 356. After step 1040 or after determining that the battery packs were not serviced at the battery service station (1038, no), or after determining that the selected waypoint is not a battery service station (1034, no), the energy-aware navigation module 332 determines (1042) whether there are any more waypoints.

If there are more waypoints in the energy plan (1044, yes), the energy-aware navigation module 332 returns to step 1002. If there are no more waypoints in the energy plan (e.g., the final destination is reached) (1044, no), the energy-aware navigation module 332 performs (1046) specified actions. For example, the energy-aware navigation module 332 may record the route taken and the stops made along the route to the profile 352 and/or the geographic location database 358. Similarly, the energy-aware navigation module 332 may transmit data about the route and/or destination the value-added services module 344, which in turn provides value-added services (e.g., coupons, etc.). In some embodiments, if the destination is associated with an offer provided by the value-added services module 344 and selected by the user of the electric vehicle (e.g., see FIG. 22 below), the energy-aware navigation module 332 notifies the value-added services module 344 that the destination was reached so that the value-added services module 344 can provide tracking information to the control center. In doing so, the service provide may receive advertisement revenue for the user arriving at the planned destination associated with the selected offer.

Users do not always use navigation services while operating vehicles. For example, the user may want to travel to multiple destinations, but only needs turn-by-turn guidance for certain portions of the trip. Thus, when the user is in a familiar area, the user may choose not to use the navigation system of the vehicle. However, when the user is in an unfamiliar area, the user may choose to use the navigation system of the vehicle. Thus, some embodiments provide at least two modes of energy management. In a first mode, the electric vehicle control system (e.g., the electric vehicle control system 107 in FIG. 3) provides visual (e.g., a map, text, etc.) and/or audio (e.g., voice, etc.) turn-by-turn guidance based on a destination received from a user of the electric vehicle and/or a profile of the user of the electric vehicle. In a second mode, the electric vehicle control system executes the energy plan, but does not provide turn-by-turn guidance. In doing so, the energy-aware navigation module 332 can still monitor the progress of the electric vehicle 102 in reaching the waypoints of the energy plan and re-compute the energy plan, if necessary, without providing audio and/or visual turn-by-turn guidance. In some embodiments, the silent navigation feature is a preference set in the profile 352. In some embodiments, the user toggles the silent navigation feature on or off during execution of the energy plan.

In embodiments where the silent navigation feature is available, step 1004 includes the operations illustrated in FIG. 11. As illustrated in FIG. 11, the energy-aware navigation module 332 determines (1102) whether silent navigation is enabled. If silent navigation is not enabled (1104, no), the energy-aware navigation module 332 provides turn-by-turn guidance during execution of the energy plan. If silent navigation is enabled (1104, yes), the energy-aware navigation module 332 disables turn-by-turn guidance during execution of the energy plan. After steps 1106 and 1108, the energy-aware navigation module 332 proceeds to step 1006.

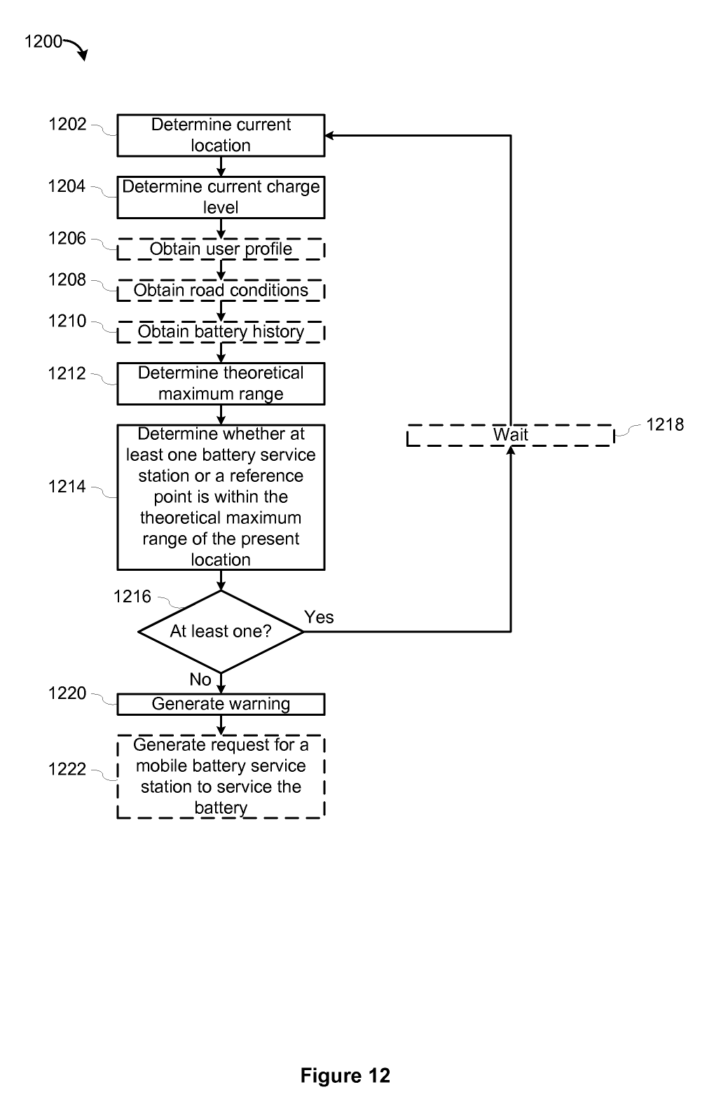

Even though the energy-aware navigation module 332 and/or the energy management module 340 may provide energy management services, the electric vehicle may still be unable to reach a destination. For example, battery service stations may become non-operational and no other battery service stations may be within range of the electric vehicle. Similarly, the battery packs of the electric vehicle may fail unexpectedly. Thus, in some embodiments, the energy-aware navigation module 332 determines whether the electric vehicle is out-of-range of a battery service station and makes a request for a mobile battery service station to service the batteries of the electric vehicle. These embodiments are discussed with reference to FIG. 12.

FIG. 12 is a flow diagram of a method 1200 for determining whether an electric vehicle is out-of-range of a battery service station, according to some embodiments. In some embodiments, the energy-aware navigation module 332 performs the following operations. The energy-aware navigation module 332 determines (1202) the current location of the electric vehicle. In some embodiments, the energy-aware navigation module 332 determines the current location based on position data received from the positioning module 322. The energy-aware navigation module 332 determines (1204) charge levels for the battery packs of the electric vehicle. In some embodiments, the energy-aware navigation module 332 determines charge levels for the battery packs of the electric vehicle based on battery status data received from the BMS module 320.

In some embodiments, the energy-aware navigation module 332 obtains (1206) the profile 352 of the user of the electric vehicle, as described above (e.g., step 508 in FIG. 5).

In some embodiments, the energy-aware navigation module 332 obtains (1208) road conditions, as described above (e.g., step 510 in FIG. 5).

In some embodiments, the energy-aware navigation module 332 obtains (1210) battery history for the one or more battery packs of the electric vehicle, as described above (e.g., step 512 in FIG. 5).

Note that steps 1202-1210 may be performed in any order.

The energy-aware navigation module 332 determines (1212) the theoretical maximum range of the electric vehicle (e.g., as described above with respect to step 514 in FIG. 5).

The energy-aware navigation module 332 then determines (1214) whether at least one battery service station or a reference point is within the theoretical maximum range of the current location. In some embodiments, the energy-aware navigation module 332 queries the battery service station database 364 to determine a set of battery service stations within the theoretical maximum range of the current location (e.g., as described above).

In some embodiments, the energy-aware navigation module 332 determines a set of battery service stations within the theoretical maximum range of the current location of the electric vehicle. As described above, the set of battery service stations may only include battery service stations that are within the theoretical maximum range of the current location of the vehicle using roads. Furthermore, the battery stations within the set of battery service stations may only include battery service stations that are available to service the battery packs of the electric vehicle.

If there is at least one battery service station within the theoretical maximum range of the current location of the electric vehicle (1216, yes), the energy-aware navigation module 332 waits (1218) for a specified amount of time and proceeds to step 1202. If there is not at least one battery service station within the theoretical maximum range of the current location of the electric vehicle (1216, no), the energy-aware navigation module 332 generates (1220) a warning. The warning may be an audio warning and/or a visual warning that is serviced by a user interface (e.g., the user interface 210 in FIG. 2, the user interface 305 in FIG. 3, etc.).

In some embodiments, the energy-aware navigation module 332 generates (1222) a request for a mobile battery service station to service the battery packs of the electric vehicle. For example, the mobile battery service station may carry charged battery packs to the electric vehicle so that the charged battery packs may be exchanged with the spent battery packs of the electric vehicle.

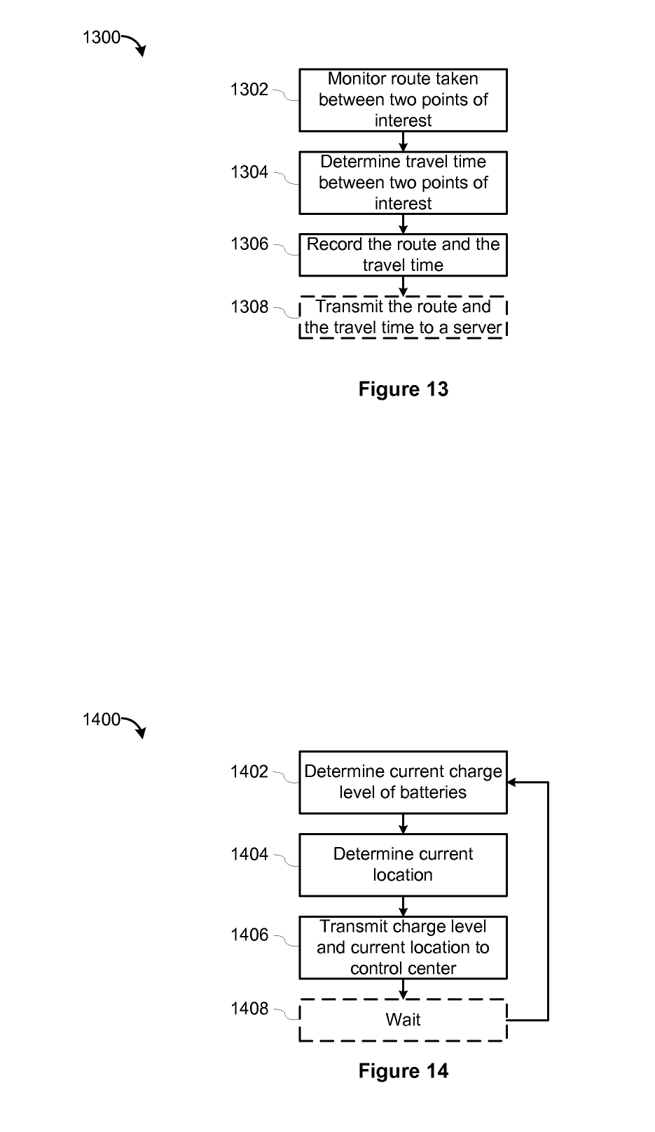

In some embodiments, the energy-aware navigation module 332 monitors routes traveled by the electric vehicle. In doing so, the energy-aware navigation module 332 may obtain data that may be used to generate the profile 352. These embodiments are discussed with reference to FIG. 13, which is a flow diagram of a method 1300 for monitoring routes traveled by an electric vehicle, according to some embodiments. The energy-aware navigation module 332 monitors (1302) the route taken between two points of interest (e.g., a home, a business, a landmark, a recreation area, a government building, etc.). For example, the energy-aware navigation module 332 may monitor position data received from the positioning module 322.

The energy-aware navigation module 332 determines (1304) the travel time between two points of interest and records (1306) the route and the travel time. For example, the energy-aware navigation module 332 may record the route and the travel time to the profile 352.

In some embodiments, the energy-aware navigation module 332 transmits (1308) the route and the travel time to a server (e.g., the control center 130, etc.). The server may then aggregate data about the user to build a profile of the user. Similarly, the server may aggregate the data about the user with data from other users to compile statistics in the aggregate about the users of electric vehicles. The route and travel time may also be used to determine current traffic conditions.

In some embodiments, the energy-aware navigation module 332 periodically transmits the current location of the electric vehicle and the charge levels of the battery packs of the electric vehicle to a control center (e.g., the control center 130 in FIG. 1). Accordingly, the control center may then monitor the present charge levels and locations of electric vehicles in order to plan overall power grid management. For example, the control center may adjust battery service plans (e.g., by reducing the rate of recharging the battery packs, rescheduling electric vehicles to other battery service stations to balance the power grid, etc.) so that the power grid is not overburdened with battery service requests. These embodiments are discussed with respect to FIG. 14.

FIG. 14 is a flow diagram of a method 1400 for monitoring charge levels of battery packs of an electric vehicle, according to some embodiments. The energy-aware navigation module 332 determines (1402) current charge levels of the battery packs of the electric vehicle. For example, the energy-aware navigation module 332 may determine the charge levels of the battery packs based on battery status data received from the BMS module 320.

The energy-aware navigation module 332 determines (1404) a current location of the electric vehicle. For example, the energy-aware navigation module 332 may determine the current location of the electric vehicle from position data received from the positioning module 322. Note that steps 1402-1404 may be performed in any order.

The energy-aware navigation module 332 then transmits (1406) the current charge levels of the battery packs and the current location to the control center (e.g., the control center 130 in FIG. 1. In some embodiments, to protect the privacy of users, the current charge levels of the battery packs and/or the current location of the electric vehicle is sent to the control center without identifiers (e.g., a vehicle identifier, a user identifier, a battery identifier, etc.). The control center may then track the current positions and current charge levels of the battery packs of a plurality of electric vehicles. The control center may then use this information to adjust battery service plans so that the power grid is not overburdened with battery service requests.

The energy-aware navigation module 332 then waits (1408) for a specified amount of time and proceeds to step 1402.

### Servicing Battery Packs

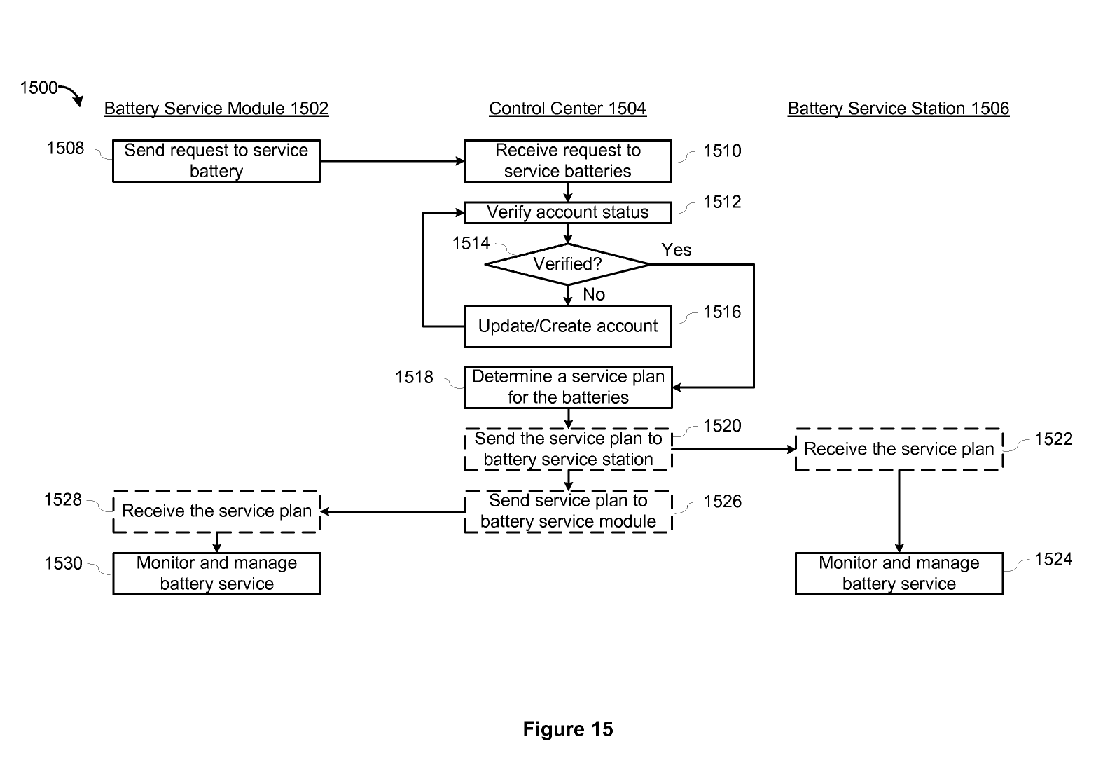

As discussed above, the battery packs of the electric vehicle may be serviced by a charge station and/or a battery exchange station. The battery service operations are discussed below with respect to FIGS. 15-21.

FIG. 15 is a flow diagram of a method 1500 for servicing battery packs of an electric vehicle, according to some embodiments. As illustrated in FIG. 15, at least a battery service module 1502 of an electric vehicle control system for the electric vehicle (e.g., the battery service module 330 in FIG. 3), a control center 1504 (e.g., the control center 130 in FIG. 1), and a battery service station 1506 (e.g., the battery service station 134 in FIG. 1) perform operations during the servicing of the battery packs of the electric vehicle.

When the electric vehicle arrives at the battery service station 1506, the battery service module 1502 sends (1508) a request to service the battery packs of the electric vehicle to the control center 1504 (e.g., the control center 130). In some embodiments, the request includes identity information including battery identifiers for the battery packs, a user identifier, a vehicle identifier, charge levels of the battery packs, types of the battery packs, etc. The battery service module 1502 may communicate with the control center 1504 via a wired connection (e.g., an Ethernet connection at the battery service station 1506) or a wireless connection (e.g., Wi-Fi, cellular, Bluetooth, etc.). The battery service module 1502 may transmit the request to a communication module of the electric vehicle (e.g., the communication module 106 in FIG. 1, the communication module 106 in FIG. 2, etc.), which in turn transmits the request to the control center 1504. In this case, the battery service module 1502 may use the one or more communication interfaces of the electric vehicle control system (e.g., the one or more communication interfaces 304) to interface with the communication module of the electric vehicle. Alternatively, the battery service module 1502 may transmit the request to the control center 1504 via the one or more communication interfaces of the electric vehicle control system (e.g., the one or more communication interfaces 304).

The control center 1504 receives (1510) the request to service the battery packs and verifies (1512) the account status for the user. For example, the control center 1504 may verify that the account for the user is current and active (e.g., the user has paid a periodic subscription fee, the user has paid off non-recurring fees, etc.). If the account status is not verified (1514, no), the control center 1504 prompts (1516) the user to update attributes of the account (e.g., payment information, subscription type, etc.) or to create a new account if the user does not have an existing account. The control center 1504 then returns to step 1512.

If the account status is verified (1514, yes), the control center 1504 determines (1518) a service plan for the battery packs. In some embodiments, the control center 1504 determines the service plan based at least in part on the charge levels of the battery packs of the electric vehicle, the battery pack types, the type and/or status of account of the user, the present status of the electric power grid, the charge levels of the battery packs of other electric vehicle, etc. The service plan may include a charge plan for recharging the battery packs of the electric vehicle, a battery exchange plan for exchanging the batteries of the electric vehicle, and/or a combination of a charge plan and a battery exchange plan. In some embodiments, the service plan includes a set of instructions that are executable by the battery service station and/or the electric vehicle (e.g., the electric vehicle control system 107 in FIG. 3). In some embodiments, the service plan includes a set of parameters that provide information about the services to be performed on the battery packs of the electric vehicle. These parameters may then be interpreted by the battery service station and/or the electric vehicle (e.g., the electric vehicle control system 107 in FIG. 3) during the battery pack service process.

In some embodiments, the control center 1504 sends (1520) the service plan to the battery service station 1506. The battery service station 1506 receives (1522) the service plan. In some embodiments, the battery service station 1506 receives the service plan from the battery service module 1502 of the electric vehicle control system. The battery service station 1506 then monitors and manages (1524) the battery service.

In some embodiments, the control center 1504 sends (1526) the service plan to the battery service module 1502. The battery service module 1502 receives (1528) the service plan. The battery service module 1502 then monitors and manages (1530) the battery service. For example, the battery service module 1502 may monitor battery status data received from a BMS module of the electric vehicle control system (e.g., the BMS module 320 in FIG. 3). Similarly, the battery service module 1502 may issue commands to a battery pack lock module of the electric vehicle (e.g., the battery pack lock module 202 in FIG. 2) to engage/disengage locks during a battery exchange operation. In some embodiments, the battery service module 1502 receives the service plan from the battery service station 1506.

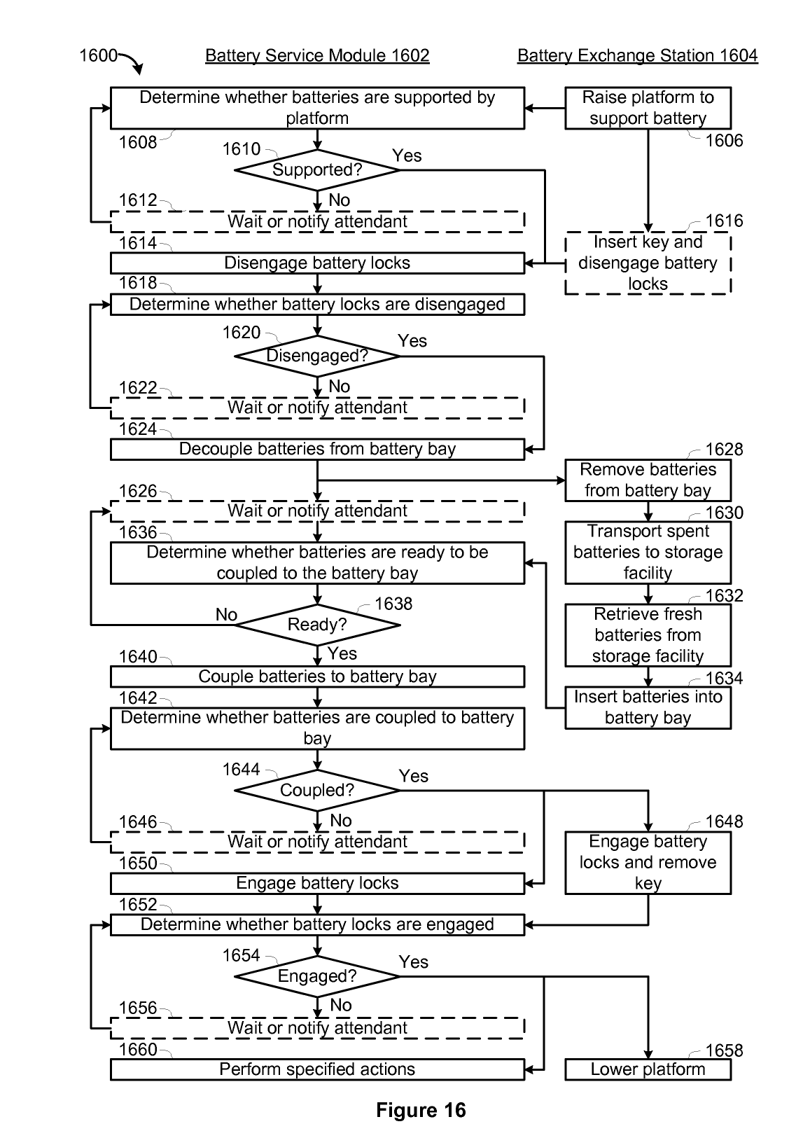

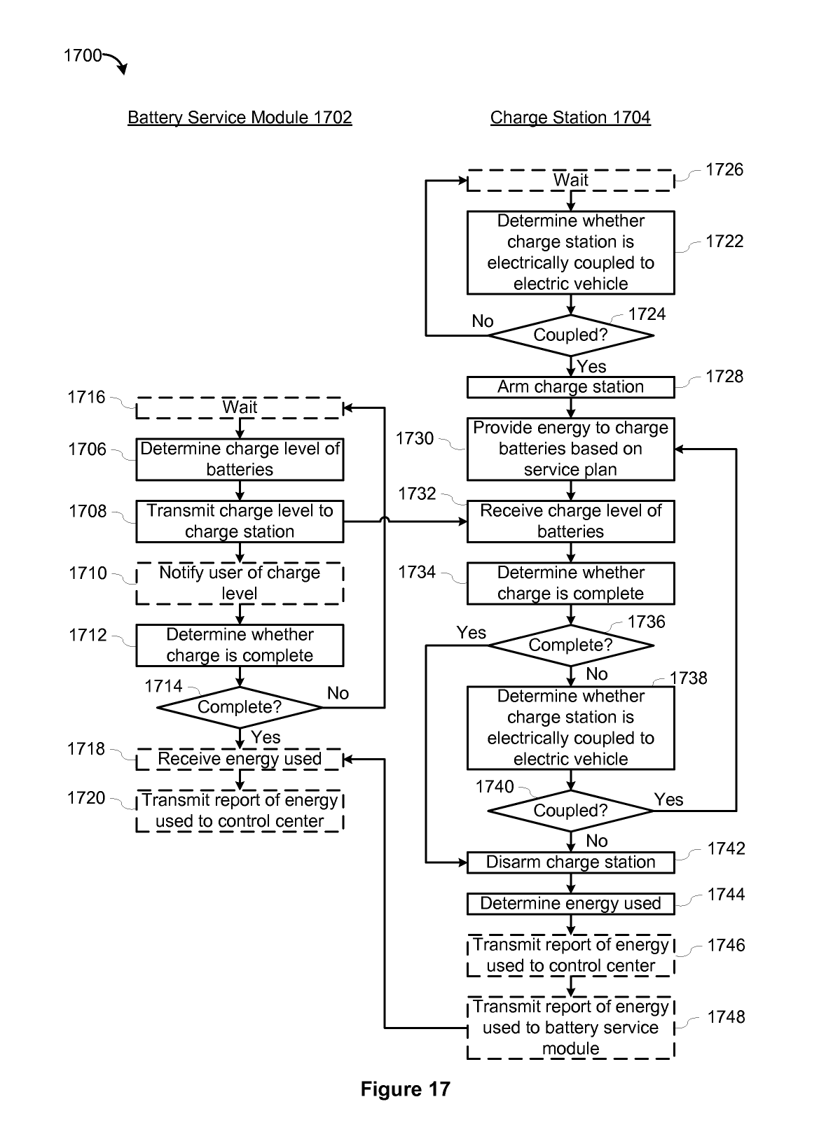

Steps 1530 and 1524 are described in more detail with respect to FIG. 16-17 below.

FIG. 16 is a flow diagram of a method 1600 for servicing battery packs of an electric vehicle at a battery exchange station 1604, according to some embodiments. As illustrated in FIG. 16, at least a battery service module 1602 of an electric vehicle (e.g., the battery service module 330 in FIG. 3) and the battery exchange station 1604 perform operations during the servicing of the battery of the electric vehicle.

When the electric vehicle is substantially aligned with a battery exchange platform of the battery exchange station 1604, the battery exchange station 1604 raises (1606) the battery exchange platform to support the battery packs of the electric vehicle. In some embodiments, the battery exchange station 1604 determines that the battery packs of the electric vehicle are supported by the battery exchange platform (e.g., using pressure sensors) and transmits a signal to the electric vehicle indicating that the battery packs are supported by the platform.

In some embodiments, the battery exchange station 1604 inserts (1616) a key into a locking mechanism for battery packs of the electric vehicle to disengage battery locks (e.g., the one or more battery pack locks 204 in FIG. 2) for the battery packs of the electric vehicle. In some embodiments, the electric vehicle includes two sets of battery pack locks. One set of battery pack locks may be locked/unlocked using the key of the battery exchange platform. Another set of battery pack locks may be (electronically) locked/unlocked by the battery service module 1602. The benefit of having two sets of locks is that if one set of locks inadvertently unlocks itself (e.g., an error in the battery service module 1602, etc.), the other set of locks prevents the battery packs from being decoupled from the electric vehicle.

The battery service module 1602 determines (1608) whether the battery packs of the electric vehicle are supported by the battery exchange platform of the battery exchange station 1604. The battery service module 1602 may make this determination based on sensor signals received from a sensor module of the electric vehicle (e.g., the sensor module 212) and/or signals sent from the battery exchange station 1604. For example, the sensor module may receive sensor signals from pressure sensors on the electric vehicle that indicate that the battery packs are supported by the platform of the battery exchange station 1604.

If the battery packs are not supported by the battery exchange platform (1610, no), the battery service module 330 waits (1612) for a specified amount of time and returns to step 1608. Alternatively, the battery service module 330 may notify an attendant of the battery exchange station 1604 that the battery exchange platform is not supporting the battery packs. The battery service module 330 may notify the attendant via a communication interface of the electric vehicle control system (e.g., the communication interfaces 304 in FIG. 3). Alternatively, the battery service module 330 may notify the attendant via the communication module of the electric vehicle (e.g., the communication module 106 in FIG. 2). The notification may be sent via a wired or wireless connection. The attendant may then manually raise the battery exchange platform.

If the battery packs are supported by the battery exchange platform (1610, yes), the battery service module 1602 disengages (1614) the battery pack locks. For example, the battery service module 1602 may instruct a battery pack lock module of the electric vehicle (e.g., the battery pack lock module 202 in FIG. 2) to disengage the battery pack locks (e.g., the one or more battery pack locks 204 in FIG. 2) that prevent hooks that couple the battery packs to the chassis of the electric vehicle from being disengaged.

The battery service module 1602 determines (1618) whether the battery pack locks are disengaged. The battery service module 1602 may make this determination based on sensor signals received from the sensor module of the electric vehicle (e.g., the sensor module 212). For example, the sensor module may receive sensor signals from pressure sensors on the electric vehicle that indicate that the battery pack locks have been disengaged.

If the battery pack locks are not disengaged (1620, no), the battery service module 1602 waits (1622) for a specified amount of time and returns to step 1618. Alternatively, the battery service module 1602 may notify an attendant that the battery pack locks are not disengaged (e.g., as described above). The attendant may then manually disengage the battery pack locks.

If the battery pack locks are disengaged (1620, yes), the battery service module 1602 decouples (1624) the battery packs from battery bays of the electric vehicle. For example, the battery service module 1602 may disengage mechanical hooks that couple the battery packs to the battery bays. In some embodiments, the battery service module 1602 notifies the battery exchange station 1604 that the battery packs have been decoupled. In some embodiments, the battery exchange station 1604 detects that the battery packs have been decoupled using sensors located on the battery exchange platform (e.g., pressure sensors that detect the weight of the battery packs on the battery exchange platform, etc.). The battery service module 1602 then waits (1626) for a specified amount of time (e.g., waits for the battery exchange station 1604 to exchange the battery packs).

After the battery packs have been decoupled from the battery bay, the battery exchange station 1604 removes (1628) the battery packs from the battery bay of the electric vehicle. The battery exchange station 1604 then transports (1630) the spent (or partially spent) battery packs to a storage facility (e.g., at the battery exchange station 1604). The battery exchange station 1604 retrieves (1632) fresh battery packs from the storage facility. The battery exchange platform of the battery exchange station 1604 then inserts (1634) the battery packs into the battery bays of the electric vehicle. In some embodiments, the battery exchange station 1604 sends signals to the battery service module 1602 indicating that the battery packs are ready to be coupled to the battery bays of the electric vehicle.

The battery service module 1602 determines (1636) whether the battery packs are ready to be coupled to the battery bay of the electric vehicle. In some embodiments, the battery service module 1602 makes this determination based on sensor signals received from the sensor module 212. For example, pressure sensors in the battery bays of the electric vehicle may indicate that the battery packs have been inserted into the battery bays of the electric vehicle. In some embodiments, the battery service module 1602 receives signals from the battery exchange station 1604 indicating that the battery packs are ready to be coupled to the battery bays of the electric vehicle.

If the battery packs are not ready to be coupled to the battery bay (1638, no), the battery service module 1602 waits (1626) for a specified amount of time and returns to step 1626. Alternatively, the battery service module 1602 may notify the attendant that the battery packs are not ready to be coupled to the battery bays (e.g., after waiting a specified time period). The attendant may then perform remedial actions (e.g., manually retrieving the battery packs, manually raising the battery exchange platform, etc.).

If the battery packs are ready to be coupled to the battery bay (1638, yes), the battery service module 1602 couples (1640) the battery packs to the battery bays of the electric vehicle. For example, the battery service module 1602 may engage mechanical hooks that couple the battery packs to the chassis of the battery bay.

The battery service module 1602 determines (1642) whether the battery packs are coupled to the battery bay of the electric vehicle. For example, the battery service module 1602 may make this determination based on sensor signals received from the sensor module.

If the battery packs are not coupled to the battery bay (1644, no), the battery service module 1602 waits (1646) for a specified amount of time and returns to step 1642. Alternatively, the battery service module 1602 may notify the attendant that the battery packs are not coupled to the battery bay. The attendant may then manually couple the battery packs to the battery bay.

If the battery packs are coupled to the battery bay (1644, yes), the battery service module 1602 engages (1650) the battery pack locks (e.g., the one or more battery pack locks 204). For example, the battery service module 1602 may instruct the battery pack lock module of the electric vehicle (e.g., the battery pack lock module 202 in FIG. 2) to engage the battery pack locks (e.g., the one or more battery pack locks 204 in FIG. 2) to prevent hooks that couple the battery packs to the chassis of the electric vehicle from being disengaged. In some embodiments, the battery exchange platform of the battery exchange station 1604 engages (1648) battery pack locks and removes the key.

The battery service module 1602 determines (1652) whether the battery pack locks are engaged. The battery service module 1602 may make this determination based on sensor signals received from the sensor module of the electric vehicle (e.g., the sensor module 212). For example, the sensor module may receive sensor signals from pressure sensors on the electric vehicle that indicate that the battery pack locks have been engaged.

If the battery pack locks have not been engaged (1654, no), the battery service module 1602 waits (1656) for a specified amount of time and returns to step 1652. Alternatively, the battery service module 1602 may notify the attendant that the battery pack locks are not engaged. The attendant may then manually engage the battery pack locks.

If the battery pack locks have been engaged (1654, yes), the battery service module 1602 performs (1660) specified actions to complete the battery exchange process. For example, the battery service module 1602 may register the new battery packs with the electric vehicle control system 107. Similarly, the battery service module 1602 may register the new battery packs with the control center (e.g., the control center 160 in FIG. 1).

The battery exchange station 1604 may then lower (1658) the battery exchange platform.

FIG. 17 is a flow diagram of a method 1700 for servicing battery packs of an electric vehicle at a charge station 1704, according to some embodiments. As illustrated in FIG. 17, at least a battery service module 1702 of an electric vehicle (e.g., the battery service module 330 in FIG. 3) and the charge station 1704 perform operations during the servicing of the battery packs of the electric vehicle.

In some embodiments, the user of the electric vehicle manually couples (mechanically and electrically) the electric vehicle to the charge station 1704 using a charge cord. In some embodiments, the charge station 1704 automatically couples (mechanically and electrically) a charge cord to the electric vehicle. In some embodiments, the electric vehicle and the charge station 1704 are electrically coupled via induction when the electric vehicle is within a specified range of the charge station 1704.

The charge station 1704 determines (1722) whether the charge station is electrically coupled to the electric vehicle. In some embodiments, the charge station 1704 makes this determination based on sensor signals received from sensors on the charge cord. In some embodiments, the charge station 1704 makes this determination based on a signal sent between the electric vehicle and the charge station 1704 via the charge cord. In some embodiments, the charge station 1704 makes this determination based on a handshake operation between the charge station 1704 and the electric vehicle. For example, if induction charging is used, the electric vehicle may send a signal to the charge station 1704 (e.g., via a wireless connection) indicating that the electric vehicle has detected the presence of the charge station 1704. The charge station 1704 may then acknowledge the detection.

If the charge station 1704 is not electrically coupled to the electric vehicle (1724, no), the charge station 1704 waits (1726) for a specified amount of time and returns to step 1720. If the charge station 1704 is electrically coupled to the electric vehicle (1724, yes), the charge station arms (1728) itself. In doing so, the charge station may enable current flow between the charge station 1704 and the electric vehicle. The charge station 1704 then provides (1730) energy to charge the battery packs of the electric vehicle based on a service plan (e.g., a service plan provided by the control center 130, etc.).

At the electric vehicle, the battery service module 1702 determines (1706) a charge level of the battery packs of the electric vehicle. The battery service module 1702 may make this determination based on battery status data received from a BMS module (e.g., the BMS module 320 in FIG. 3). The battery service module 1702 then transmits (1710) the charge levels to the charge station 1704 (e.g., via a wireless connection).

In some embodiments, the battery service module 1702 notifies (1710) the user of the electric vehicle of the charge levels of the battery packs. For example, the battery service module 1702 may transmit the charge levels of the battery packs to a mobile phone of the user.

The battery service module 1702 determines (1712) whether the charge is complete. If the charge is not complete (1714, no), the battery service module 1702 waits (1716) for a specified amount of time and returns to step 1706. In some embodiments, if the charge is complete, the battery service module 1702 receives (1718) a report of the energy used to charge the battery packs. In some embodiments, the battery service module 1702 receives the report from the charge station 1704. In some embodiments, the battery service module 1702 receives the report from the control center. In these embodiments, the battery service module 1702 transmits (1720) the report to the control center.

After the battery service module 1702 transmits the charge levels to the charge station 1704, the charge station 1704 receives (1732) the charge levels of the battery packs and determines (1734) whether the charge process is complete. For example, the charge station 1704 may make this determination based at least in part on the charge levels of the battery packs received from the battery service module 1702 and the service plan.

If the charge process is not complete (1736, no), the charge station 1704 determines (1738) whether the charge station is electrically coupled to the electric vehicle. Note that the charge station may no longer be electrically coupled to the electric vehicle because the user disconnected the plug. If the charge station is electrically coupled to the electric vehicle (1740, yes), the charge station 1704 returns to step 1730.

If the charge process is complete (1736, yes) or if the charge station 1704 is not electrically coupled to the electric vehicle (1740, no), the charge station 1704 disarms (1742) the charge station. For example, the charge station 1704 may disable the current flow from the charge station 1704 to the electric vehicle. The charge station 1704 then determines (1744) the amount of energy used during the charging process. In some embodiments, the charge station 1704 transmits (1746) the energy used to the control center (e.g., via a wired or wireless connection). In some embodiments, the charge station 1704 transmits a report of the amount of energy used during the charging process to the battery service module 1702.

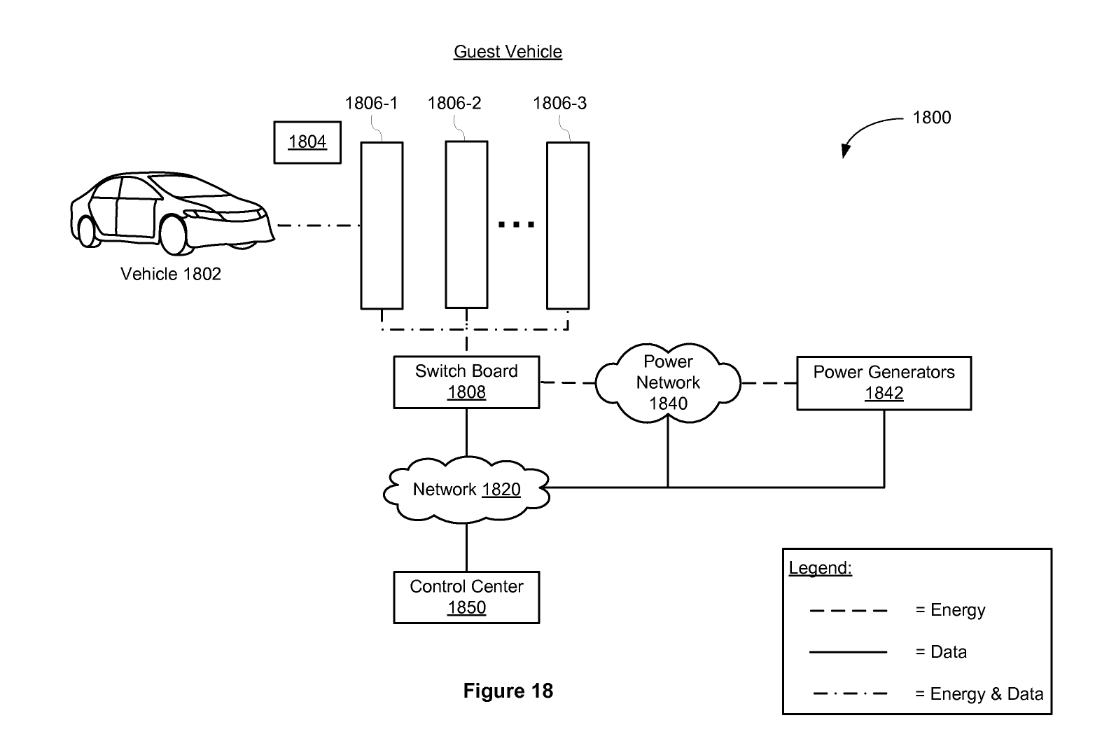

FIGS. 18-21 illustrate exemplary charging scenarios.

FIG. 18 is a block diagram 1800 illustrating data and energy flows for an electric vehicle 1802 being charged at public charge stations 1806, according to some embodiments. In FIG. 18, the electric vehicle 1802 is an electric vehicle that does not include an electric vehicle control system as described herein. Thus, the electric vehicle 1802 may be referred to as a “guest vehicle.”

In some embodiments, the charge stations 1806 are coupled to a switchboard 1808. The switchboard 1808 provides energy to the charge stations 1806. The switchboard 1808 also communicates with the charge stations 1806 via a data network (e.g., a wired network, a wireless network, etc.). For example, the charge stations 1806 may provide status information (e.g., the amount of energy being used by the charge station, the type of vehicle coupled to the charge station, etc.) of the charge stations 1806 to the switchboard 1808.

In some embodiments, the switchboard 1808 is coupled to a power network 1840 that provides energy from power generators 1842. In some embodiments, the power generators 1842 include fossil fuel power generators, hydroelectric power generators, wind power generators, solar power generators, etc. In some embodiments, the switchboard 1808 is coupled to a data network 1820. The data network 1820 may be coupled to a control center 1850 (e.g., the control center 130 in FIG. 1) and the power generators 1842. In some embodiments, the power generators 1842 provide data to the control center 1850 via the data network 1820 that indicates the present power-generation capacity, the present power draw on the power grid, etc. In some embodiments, the control center 1850 regulates the energy usage of the battery service stations (e.g., the charge stations 1806) so that the energy usage does not exceed the power-generation capacity. In some embodiments, the control center 1850 modifies the service plans for electric vehicles in accordance with the data received from the power generators 1842.

In some embodiments, when the electric vehicle 1802 arrives at a charge station 1806-1, the user of the electric vehicle 1802 uses an identity card 1804 to request energy from the charge station 1806-1. In some embodiments, the energy request includes an identifier for the user (e.g., an account), the type of battery packs of the electric vehicle 1802, and an amount of energy desired. The charge station 1806-1 transmits the energy request to the control center 1850 via the data network 1820. The control center 1850 then generates a service plan based on the energy request and the present status of the power network 1840 and transmits the service plan to the charge station 1806-1. The charge station 1806-1 then manages the charging of the battery packs of the electric vehicle 1802 based on the service plan.

In some embodiments, the electric vehicle 1802 communicates with the charge station 1806-1 via a charge cord. For example, the communication may use the SAE J1772 communication protocol. The electric vehicle 1802 may transmit charge levels of the battery packs of the electric vehicle 1802 to the charge station 1806-1 so that the charge station 1806-1 may manage the charging process.

In some embodiments, the electric vehicle 1802 communicates with the charge station 1806-1 via a local wireless network (e.g., a Bluetooth network, a Wi-Fi network, etc.).

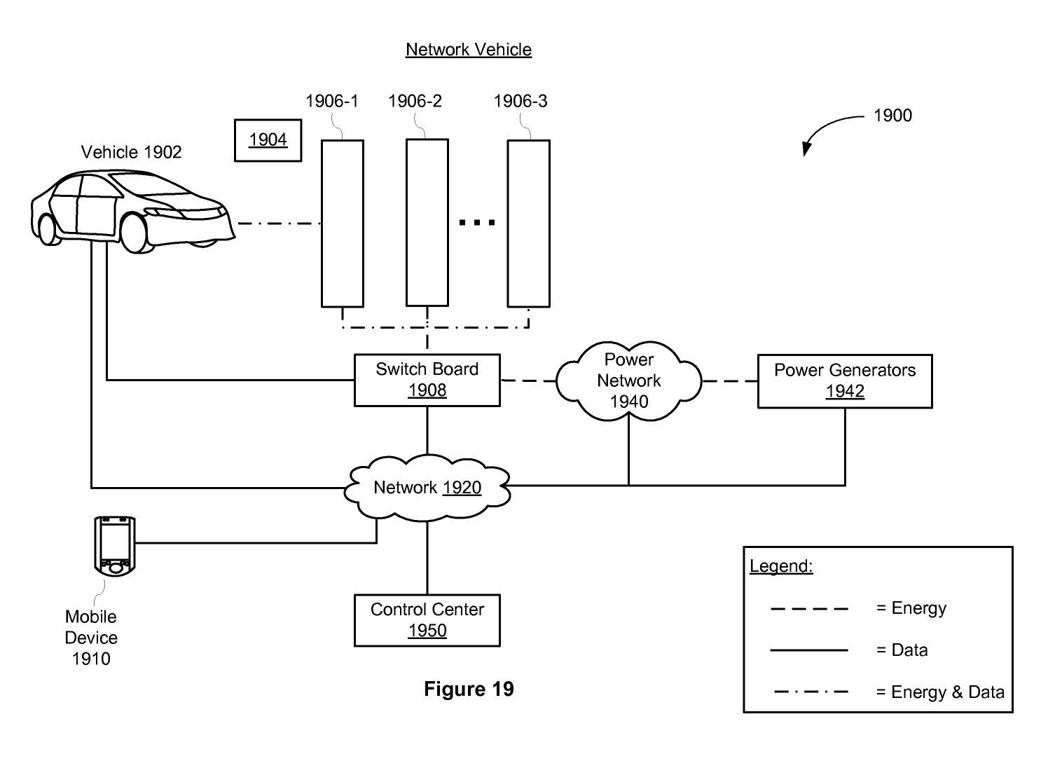

FIG. 19 is a block diagram 1900 illustrating data and energy flows for an electric vehicle 1902 being charged at public charge stations 1906, according to some embodiments. In FIG. 19, the electric vehicle 1902 is an electric vehicle that includes an electric vehicle control system as described herein.

In some embodiments, the charge stations 1906 are coupled to a switchboard 1908. The switchboard 1908 may provide energy to the charge stations 1906. In some embodiments, the switchboard 1908 communicates with the charge stations 1906 via a data network (e.g., a wired network, a wireless network, etc.). For example, the charge stations 1906 may provide status information (e.g., the amount of energy being used by the charge station, the type of vehicle coupled to the charge station, etc.) of the charge stations 1906 to the switchboard 1908.

In some embodiments, the switchboard 1908 is coupled to a power network 1940 that provides energy from power generators 1942. In some embodiments, the power generators 1942 may include fossil fuel power generators, hydroelectric power generators, wind power generators, solar power generators, etc. In some embodiments, the switchboard 1908 is coupled to a data network 1920. The data network 1920 may be coupled to a control center 1950 (e.g., the control center 130 in FIG. 1) and the power generators 1942. In some embodiments, the power generators 1942 provide data to the control center 1950 via the data network 1920 that indicates the present power-generation capacity, the present power draw on the power grid, etc. In some embodiments, the control center 1950 regulates the energy usage of the battery service stations (e.g., the charge stations 1906) so that the energy usage does not exceed the power-generation capacity. In some embodiments, the control center 1950 modifies the service plans for electric vehicles in accordance with the data received from the power generators 1942.

In some embodiments, when the electric vehicle 1902 arrives at a charge station 1906-1, the user of the electric vehicle 1902 uses an identity card 1904 to request energy from the charge station 1906-1. In some embodiments, the energy request includes an identifier for the user (e.g., an account), the type of battery packs of the electric vehicle 1902, and an amount of energy desired. The charge station 1906-1 transmits the energy request to the control center 1950 via the data network 1920. The control center 1950 then generates a service plan based on the energy request and the present status of the power network 1940 and transmits the service plan to the charge station 1906-1. The charge station 1906-1 then manages the charging of the battery packs of the electric vehicle 1902 based on the service plan.

Alternatively, the electric vehicle control system (e.g., the electric vehicle control system 107) may generate an energy request. The electric vehicle control system may transmit the energy request to the charge station 1906-1, which in turn transmits the energy request to the control center 1950 via the data network 1920. Alternatively, the electric vehicle control system may transmit the energy request to the control center 1950 via the data network 1920. The control center 1950 then generates a service plan based on the energy request and the present status of the power network 1940 and transmits the service plan to the electric vehicle control system. The electric vehicle control system may then transmit the service plan to the charge station 1906-1. The charge station 1906-1 then manages the charging of the battery packs of the electric vehicle 1902 based on the service plan.

In some embodiments, the electric vehicle 1902 communicates with the charge station 1906-1 via a charge cord. For example, the communication may use the SAE J1772 communication protocol. The electric vehicle 1902 may transmit charge levels of the battery packs of the electric vehicle 1902 to the charge station 1906-1 so that the charge station 1906-1 may manage the charging process.

In some embodiments, the electric vehicle 1902 communicates with the charge station 1906-1 via a local wireless network (e.g., a Bluetooth network, a Wi-Fi network, etc.).

In some embodiments, the electric vehicle control system monitors the charge process and transmits the present charge levels to a mobile device 1910 of the user via the data network 1920.

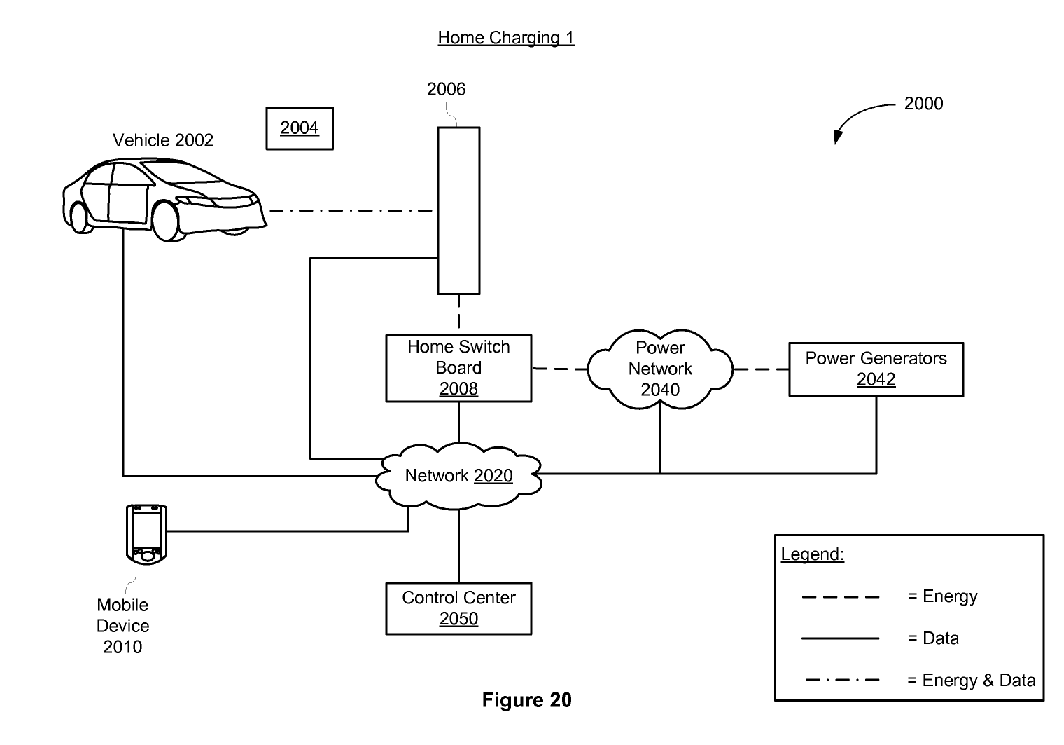

FIG. 20 is a block diagram 2000 illustrating data and energy flows for an electric vehicle 2002 being charged at a home charge station 2006, according to some embodiments. In FIG. 20, the electric vehicle 2002 is an electric vehicle that includes an electric vehicle control system as described herein.

In some embodiments, the home charge station 2006 is coupled to a home switchboard 2008. The home switchboard 2008 provides energy to the home charge station 2006.

In some embodiments, the home switchboard 2008 is coupled to a power network 2040 that provides energy from power generators 2042. In some embodiments, the power generators 2042 may include fossil fuel power generators, hydroelectric power generators, wind power generators, solar power generators, etc.

In some embodiments, the electric vehicle 2002 is coupled to a data 2020 (e.g., a wired connection, a wireless connection, etc.). In some embodiments, the data network 2020 is coupled to a control center 2050 (e.g., the control center 130 in FIG. 1) and the power generators 2042. The power generators 2042 may provide data to the control center 2050 via the data network 2020 that indicates the present power-generation capacity, the present power draw on the power grid, etc. In some embodiments, the control center 2050 regulates the energy usage of the battery service stations (e.g., the home charge station 2006) so that the energy usage does not exceed the power-generation capacity. In some embodiments, the control center 2050 modifies the service plans for electric vehicles in accordance with the data received from the power generators 2042.

In some embodiments, when the electric vehicle 2002 arrives at the home charge station 2006, the electric vehicle control system generates an energy request. The electric vehicle control system (e.g., the electric vehicle control system 107 in FIG. 3) transmits the energy request to the control center 2050 via the network 2020. The control center 2050 then generates a service plan based on the energy request and the present status of the power network 2040 and transmits the service plan to the electric vehicle control system. The electric vehicle control system then transmits the service plan to the home charge station 2006. The home charge station 2006 then manages the charging of the battery packs of the electric vehicle 2002 based on the service plan.

In some embodiments, the electric vehicle 2002 communicates with the home charge station 2006 via a charge cord. For example, the communication may use the SAE J1772 communication protocol. The electric vehicle 2002 may transmit charge levels of the battery packs of the electric vehicle 2002 to the home charge station 2006 so that the home charge station 2006 may manage the charging process.

In some embodiments, the electric vehicle 2002 communicates with the home charge station 2006 via a local wireless network (e.g., a Bluetooth network, a Wi-Fi network, etc.).

In some embodiments, the electric vehicle control system monitors the charge process and transmits the present charge levels to a mobile device 2010 of the user via the network 2020.

After the charging process is complete, the home charge station 2006 transmits a report of the energy used to the electric vehicle control system. The electric vehicle control system then transmits the report to the control center 2050.

FIG. 21 is a block diagram 2100 illustrating data and energy flows for an electric vehicle 2102 being charged at a home charge station 2106, according to some embodiments. In FIG. 21, the electric vehicle 2102 is an electric vehicle that includes an electric vehicle control system as described herein.

In some embodiments, the home charge station 2106 is coupled to a home meter 2108. The home meter 2108 provides energy to the home charge station 2106. The home meter 2108 also communicates with the home charge station 2106 via a local data network (e.g., a wired network, a wireless network, etc.). For example, the home charge station 2106 may provide status information (e.g., the amount of energy being used by the charge station, the type of vehicle coupled to the charge station, etc.) of the home charge station 2106 to the home meter 2108.

In some embodiments, the home meter 2108 is coupled to a transformer 2112 that receives energy from a power network 2140. The power network 2140 receives energy from power generators 2142. In some embodiments, the power generators 2142 may include fossil fuel power generators, hydroelectric power generators, wind power generators, solar power generators, etc. The home meter 2108 may communicate with the transformer 2112 via a data network.

In some embodiments, the electric vehicle 2102 is coupled to a data network 2120 (e.g., a wired connection, a wireless connection, etc.). In some embodiments, the data network 2120 is coupled to a control center 2150 (e.g., the control center 130 in FIG. 1) and the power generators 2142. The power generators 2142 provide data to the control center 2150 via the data network 2120 that indicates the present power-generation capacity, the present power draw on the power grid, etc. In some embodiments, the control center 2150 regulates the energy usage of the battery service stations (e.g., the home charge station 2106) so that the energy usage does not exceed the power-generation capacity. In some embodiments, the control center 2150 modifies the service plans for electric vehicles in accordance with the data received from the power generators 2142.

In some embodiments, when the electric vehicle 2102 arrives at the home charge station 2106, the electric vehicle control system generates an energy request. The electric vehicle control system transmits the energy request to the control center 2150 via the network 2120. In some embodiments, the control center 2150 generates a service plan based on the energy request and the present status of the power network 2140, and transmits the service plan to a utility grid management system 2130. The utility grid management system 2130 then transmits the service plan to the home meter 2108, which in turn transmits the service plan to the home charge station 2106. The home charge station 2106 then manages the charging of the battery packs of the electric vehicle 2102 based on the service plan.

In some embodiments, the electric vehicle 2102 communicates with the home charge station 2106 via a charge cord. For example, the communication may use the SAE J1772 communication protocol. The electric vehicle 2102 may transmit charge levels of the battery packs of the electric vehicle 2102 to the home charge station 2106 so that the home charge station 2106 may manage the charging process.

In some embodiments, the electric vehicle 2102 communicates with the home charge station 2106 via a local wireless network (e.g., a Bluetooth network, a Wi-Fi network, etc.).

In some embodiments, the electric vehicle control system monitors the charge process and transmits the present charge levels to a mobile device 2110 of the user.

After the charging process is complete, the home charge station 2106 transmits a report of the energy used to the electric vehicle control system. The electric vehicle control system then transmits the report to the control center 2150.

### Providing Value-Added Services

Aside from providing energy management services, the electric vehicle control system 107 may also provide value-added services via the value-added services module 344. The value-added services are described in more detail with respect to FIG. 22, which is a flow diagram of a method 2200 for providing value-added services to an electric vehicle, according to some embodiments. The value-added services module 344 receives (2202) the search query. The search query may include a search for a point of interest (e.g., a coffee shop within a specified distance of the current location of the electric vehicle), a search for an address, a search for a product, and/or a search for a service.

The value-added services module 344 retrieves (2204) search results based on the search query and presents (2206) the search results to the user of the electric vehicle. In some embodiments, the value-added services module 344 presents the search results in the user interface 305 of the electric vehicle control system 107. In some embodiments, the value-added services module 344 presents the search results in a user interface of a positioning system (e.g., the positioning system 105 in FIG. 2). In some embodiments, the value-added services module 344 presents the search results in the user interface 210. The value-added services module 344 may present a visual representation of the results (e.g., text, map, etc.), an audio representation of the results (e.g., voice, etc.), or a combination thereof.

The user of the electric vehicle may then select one of the search results. The value-added services module 344 receives (2208) a selected search result. The selected search result may be the destination. The value-added services module 344 then determines (2210) offers within a specified distance of the selected search result. For example, the offers may include coupons, sales, promotional discounts, etc.

The value-added services module 344 then presents (2212) the offers to the user. Again, the value-added services module 344 may present a visual representation of the offers (e.g., text, map, etc.), an audio representation of the offers (e.g., voice, etc.), or a combination thereof.

In some embodiments, the value-added services module 344 sends (2214) tracking information about the offers presented to the user to a control center (e.g., the control center 130 in FIG. 1). In doing so, a service provider may receive advertisement revenue for displaying the offers. In some embodiments, the service provider is the same entity as the entity that operates the control center.

The value-added services module 344 determines (2216) whether the user selected an offer. If the user selected an offer (2218, yes), the value-added services module 344 receives (2220) the selected offer. In some embodiments, the value-added services module 344 sends (2222) tracking information about the offer selected to the control center. In doing so, the service provider may receive advertisement revenue for generating a “clickthrough.” The energy-aware navigation module 332 sets (2224) the selected search result as the destination and proceeds to step 402 in FIG. 4. The selected offer may be associated with a destination. In this case, the destination associated with the selected offer is used. If a destination is not associated with the offer, the destination associated with the selected search result may be used. In some embodiments, the energy-aware navigation module 332 generates an energy plan to a charge station that is closest (and that is available) to a location associated with the selected offer. For example, if the selected offer was for a discount on coffee at a coffee shop, the energy-aware navigation module 332 may generate an energy plan to a charge station that is located in a parking lot that is near the coffee shop.

If an offer is not selected (2218, no), the energy-aware navigation module 332 sets (2224) the selected search result as the destination (e.g., the destination associated with the selected search result) and proceeds to step 402 in FIG. 4.

In some embodiments, when the user arrives at the destination associated with the offer, the energy-aware navigation module 332 sends tracking information to the control center that indicates that the user arrived at the destination. In doing so, the service provider may receive advertisement revenue for the user arriving at the destination. In some embodiments, the service provider receives advertisement revenue when the user makes a purchase at a business associated with the offer.

The methods described herein may be governed by instructions that are stored in a computer readable storage medium and that are executed by one or more processors of one or more computer systems. Each of the operations shown in FIGS. 4-6, 8, and 10-22 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for managing energy usage of an at least partially electric vehicle, comprising:
at a computer system of the at least partially electric vehicle, the computer system including one or more processors, and memory storing one or more programs, and a display device, the one or more processors executing the one or more programs to perform the operations of:
receiving a charge level of at least one battery of the at least partially electric vehicle;
receiving a current location of the at least partially electric vehicle;
determining a theoretical maximum range of the at least partially electric vehicle based on the current location of the at least partially electric vehicle and the charge level of the at least one battery of the at least partially electric vehicle;
displaying on the display device a geographic map including the current location of the at least partially electric vehicle; and
displaying a first boundary on the geographic map indicating the maximum theoretical range of the at least partially electric vehicle.

2. The method of claim 1, further comprising displaying one or more visual indicators on the geographic map to indicate that locations outside of the first boundary are unreachable by the at least partially electric vehicle based at least in part on the current location and the theoretical maximum range of the at least partially electric vehicle.

3. The method of claim 1, further comprising:
determining a second boundary that is a predetermined distance from a reference point, wherein the predetermined distance is the farthest destination that the at least partially electric vehicle can travel to and still be able to return to the reference point; and
displaying the second boundary on the geographic map.

4. The method of claim 3, wherein the reference point is the point at which the at least partially electric vehicle spends the most time charging the at least one battery of the at least partially electric vehicle.

5. The method of claim 4, wherein the reference point is selected from the group consisting of a home of a user of the at least partially electric vehicle and an office of a user of the at least partially electric vehicle.

6. The method of claim 1, further comprising generating an energy plan for the at least partially electric vehicle.

7. The method of claim 6, wherein the energy plan includes:
one or more routes;
a destination; and
one or more battery service stations at which the at least one battery may be serviced.

8. The method of claim 6, wherein generating the energy plan for the at least partially electric vehicle includes:
determining whether the at least partially electric vehicle can reach a predefined location based on the theoretical maximum range;
in response to determining that the at least partially electric vehicle cannot reach the predefined location,
determining a battery service station within the theoretical maximum range of the current location of the at least partially electric vehicle at which the at least one battery of the at least partially electric vehicle may be serviced; and
adding the battery service station to the energy plan.

9. The method of claim 8, wherein after adding a battery service station to the energy plan, the method further comprises scheduling time at the battery service station to service the at least one battery of the at least partially electric vehicle.

10. The method of claim 9, wherein scheduling time at the battery service station to service the at least one battery of the at least partially electric vehicle includes scheduling time at the battery service station to service the at least one battery of the at least partially electric vehicle based on an estimated time that the at least partially electric vehicle will arrive at the battery service station.

11. The method of claim 8, wherein the predefined location is selected from the group consisting of:
a home of the user;
a workplace of the user; and
a location where the at least partially electric vehicle is charged.

12. The method of claim 11, further comprising in response to determining that the at least partially electric vehicle can reach the predefined location, repeating the operations of claim 1.

13. The method of claim 11, further comprising:
generating a route from the current location of the at least partially electric vehicle to the battery service station; and
adding the route to the energy plan.

14. The method of claim 8, wherein the battery service station is selected from the group consisting of:
charge stations that recharge the one or more battery packs of the vehicle;
battery exchange stations that replace a spent battery of the vehicle with a charged battery; and
any combination of the aforementioned battery service stations.

15. The method of claim 8, wherein the predefined location is selected from the group consisting of:
a user-specified destination;
a battery service station;
a destination determined based on a user profile; and
a destination determined based on aggregate user profile data.

16. The method of claim 15, further comprising:
determining the theoretical maximum range of the at least partially electric vehicle after the at least one battery is serviced at the battery service station;
determining whether the at least partially electric vehicle can reach the predefined location based on the theoretical maximum range;
in response to determining that the at least partially electric vehicle cannot reach the predefined location,
determining a next battery service station within the theoretical maximum range of a previous battery service station in the energy plan and on a route to the predefined location;
adding the next battery service station to the energy plan; and
repeating the operations of claim 16 until the predefined location is reachable.

17. The method of claim 16, further comprising:
generating a route from the current location of the at least partially electric vehicle to the destination, wherein the route includes stops at the battery service stations in the energy plan; and
adding the route to the energy plan.

18. The method of claim 15, further comprising in response to determining that the at least partially electric vehicle can reach the destination,
generating a route from the current location of the at least partially electric vehicle to the destination; and
adding the route to the energy plan.

19. The method of claim 1, wherein the theoretical maximum range is based at least in part on:
the charge level of the at least one battery of the at least partially electric vehicle;
the current location of the at least partially electric vehicle;
a profile of the user;
properties of at least one electric motor of the at least partially electric vehicle;
types of terrain on which roads are situated;
a speed of the at least partially electric vehicle; and
any combination of the aforementioned elements.

20. The method of claim 1, wherein the theoretical maximum range is adjusted to provide a margin of safety.

21. The method of claim 1, further comprising:
determining whether a silent navigation mode is enabled; and
in response to determining that the silent navigation mode is not enabled, providing guidance based on the energy plan.

22. The method of claim 21, further comprising in response to determining that the silent navigation mode is enabled, disabling guidance based on the energy plan.

23. The method of claim 21, wherein the guidance includes turn-by-turn guidance.

24. The method of claim 21, wherein the guidance is selected from the group consisting of:
visual guidance;
audio guidance; and
any combination of the aforementioned guidance.

25. The method of claim 1, wherein receiving the current location of the at least partially electric vehicle includes receiving the current location of the at least partially electric vehicle from a global satellite navigation system.

26. The method of claim 1, further comprising:
receiving an energy plan for the at least partially electric vehicle;
providing guidance based on the energy plan; and
periodically determining whether the energy plan is still valid.

27. The method of claim 1, further comprising:
at a computer system remote from the at least partially electric vehicle, the computer system including one or more processors and memory storing one or more programs, the one or more processors executing the one or more programs to perform the operations of:
receiving a request to service the at least one battery of the at least partially electric vehicle; and
in response to the request, generating a service plan to service the at least one battery of the at least partially electric vehicle.

28. The method of claim 1, further comprising:
transmitting to a server a request to service the at least one battery of the at least partially electric vehicle;
in response to the request, receiving from the server a service plan; and
managing the service plan.

29. The method of claim 28, wherein the service plan indicates that the at least one battery of the at least partially electric vehicle is to be exchanged for at least one charged battery, and wherein the method further comprises facilitating the exchanging of the at least one battery for the at least one charged battery.

30. A system for managing energy usage of an at least partially at least partially electric vehicle, comprising:
one or more processors;
memory; and
one or more programs stored in the memory, the one or more programs comprising instructions to:
receive a charge level of at least one battery of the at least partially at least partially electric vehicle;
receive a current location of the at least partially at least partially electric vehicle; and
determine a theoretical maximum range of the at least partially at least partially electric vehicle based on the current location of the at least partially at least partially electric vehicle and the charge level of the at least one battery of the at least partially at least partially electric vehicle.

31. A computer readable storage medium storing one or more programs configured for execution by a computer, the one or more programs comprising instructions to:
receive a charge level of at least one battery of the at least partially electric vehicle;
receive a current location of the at least partially electric vehicle; and
determine a theoretical maximum range of the at least partially electric vehicle based on the current location of the at least partially electric vehicle and the charge level of the at least one battery of the at least partially electric vehicle.
